(19) United States
(12) Patent Application Publication
(10) Pub. No.: US 2018/0322466 A1
(43) Pub. Date: Nov. 8, 2018

(54) Method Of Connecting Applicants With Open Employment Positions Using Cognitive Aptitude Games

(71) Applicant: CRITERIA CORP., West Hollywood, CA (US)

(72) Inventors: Joshua Evans Millet, Los Angeles, CA (US); Wayne Chuen, Los Angeles, CA (US); Michelle Diane Silverstein, Los Angeles, CA (US); Kristine Jennifer Yee, Montebello, CA (US); Stephen Matthew Gordon, Los Angeles, CA (US)

(21) Appl. No.: 15/965,465

(22) Filed: Apr. 27, 2018

Related U.S. Application Data
(60) Provisional application No. 62/501,255, filed on May 4, 2017.

(51) Int. Cl. G06Q 10/10; G06Q 10/06; G09B 5/06; G09B 19/22; A63F 13/798

(52) U.S. Cl. CPC G06Q 10/1053; G06Q 10/063112; A63F 13/798; G09B 19/22; G09B 5/06

(57) ABSTRACT

A system and method of connecting job seekers and employers with job openings that requires the job seekers to play cognitive aptitude games. Based on the scores achieved by the job seekers, the system matches the job seeker with job openings. The user may then apply for those job openings. The user may also enter work history information into the system so employers may review job seekers and provide the job seekers with employment opportunities.

### CROSS-REFERENCE TO RELATED APPLICATIONS

This Application claims the benefit of U.S. Provisional Patent Application No. 62/501,255, filed on May 4, 2017, entitled “METHOD OF CONNECTING APPLICANTS WITH OPEN EMPLOYMENT POSITIONS USING COGNITIVE APTITUDE GAMES”, the contents of which are expressly incorporated herein by this reference, and to which priority is claimed.

### FIELD OF USE

This invention is related to using cognitive aptitude games to connect job candidates with open employment positions.

### BACKGROUND

As technology has become more important in the global economy, finding qualified and desirable applicants has become more and more important. Although the internet has generally made it easier for candidates to find open positions for which they might be qualified, the internet has not necessarily made it easier for employers to assess the quality and acceptability of the applicants that elect to apply for an open position.

Companies have been identifying talented job seekers using cognitive aptitude tests for at least the last ten years. Employers specifically use testing portfolios, including cognitive aptitude, personality, and basic skills tests, to test job applicants and identify the best talent out of the candidates who apply for their employment positions. However, talented job seekers, who may not be aware of their talent and/or may not even have an employment history, do not have a way to be matched with employers seeking talented, qualified job applicants. Employers and potential employees have not been using games, but rather tests, to determine the cognitive aptitude and suitability of the potential employee.

While there are systems that use gamified assessments, they are distributing the games as part of an employer's hiring funnel. They are not a candidate-facing talent surfacing engine that uses games to identify job-relevant talent signals from brain games.

Thus, there is a need in the art for the present system and method for using cognitive aptitude games to connect those seeking employment with employers that have open positions.

### BRIEF DESCRIPTION OF DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is an illustration of a graphical user interface of one embodiment of the system and shows the splash page and create an account/login screen.

FIG. 2 is an illustration of a graphical user interface of another embodiment of the system and shows the splash page and create an account/login screen.

FIG. 3 is an illustration of a graphical user interface of another embodiment of the system and shows the splash page and create an account/login screen.

FIG. 4 is an illustration of a graphical user interface of one embodiment of the system and shows the account setup page.

FIG. 5 is an illustration of a graphical user interface of one embodiment of the system and shows the email sign in page.

FIG. 6 is an illustration of a graphical user interface of another embodiment of the system and shows the forgot password page.

FIG. 7 is an illustration of a graphical user interface of one embodiment of the system and shows the create password page.

FIG. 8 is an illustration of a graphical user interface of one embodiment of the system and shows one of the pages that gathers information about the user.

FIG. 9 is an illustration of a graphical user interface of one embodiment of the system and shows that the user may select the types of jobs in which the user is interested.

FIG. 10 is an illustration of a graphical user interface of one embodiment of the system and shows that the user may provide additional information about job types being sought, location, experience, and willingness to relocate.

FIG. 11 is an illustration of a graphical user interface of one embodiment of the system and shows the first dashboard page.

FIG. 12 is an illustration of a graphical user interface of one embodiment of the system and shows the second dashboard page.

FIG. 13 is an illustration of a graphical user interface of one embodiment of the system and shows the third dashboard page.

FIG. 14 is an illustration of a graphical user interface of one embodiment of the system and shows the start page for a cognitive aptitude game that tests attention to detail.

FIG. 15 is an illustration of a graphical user interface of one embodiment of the system and shows a mid-game page for a cognitive aptitude game that tests attention to detail.

FIG. 16 is an illustration of a graphical user interface of one embodiment of the system and shows an end-game page for a cognitive aptitude game that tests attention to detail.

FIG. 17 is an illustration of a graphical user interface of one embodiment of the system and shows the summary performance details for a cognitive aptitude game that tests attention to detail.

FIG. 18 is an illustration of a graphical user interface of one embodiment of the system and shows a summary performance detail page for a user.

FIG. 19 is an illustration of a graphical user interface of one embodiment of the system and shows a levels detail page.

FIG. 20 is an illustration of a graphical user interface of one embodiment of the system and shows a rank of nearby players page.

FIG. 21 is an illustration of a graphical user interface of one embodiment of the system and shows a rank of those looking for software development jobs.

FIG. 22 is an illustration of a graphical user interface of one embodiment of the system and shows a user jobs setup page.

FIG. 23 is an illustration of a graphical user interface of one embodiment of the system and shows a list of jobs of interest to select.

FIG. 24 is an illustration of a graphical user interface of one embodiment of the system and shows an edit profile page.

FIG. 25 is an illustration of a graphical user interface of one embodiment of the system and shows the start page for a cognitive aptitude game that tests memory.

FIG. 26 is an illustration of a graphical user interface of one embodiment of the system and shows a game page for a cognitive aptitude game that tests memory.

FIG. 27 is an illustration of a graphical user interface of one embodiment of the system and shows another game page for a cognitive aptitude game that tests memory.

FIG. 28 is an illustration of a graphical user interface of one embodiment of the system and shows the start page for a cognitive aptitude game that tests vocabulary.

FIG. 29 is an illustration of a graphical user interface of one embodiment of the system and shows a game page for a cognitive aptitude game that tests vocabulary.

FIG. 30 is an illustration of a graphical user interface of one embodiment of the system and shows another start page for a cognitive aptitude game that tests vocabulary.

FIG. 31 is an illustration of a graphical user interface of one embodiment of the system and shows another game page for a cognitive aptitude game that tests vocabulary.

FIG. 32 is an illustration of a graphical user interface of one embodiment of the system and shows a start page for a cognitive aptitude game that tests perception.

FIG. 33 is an illustration of a graphical user interface of one embodiment of the system and shows a game page for a cognitive aptitude game that tests perception.

FIG. 34 is an illustration of a graphical user interface of one embodiment of the system and shows another game page for a cognitive aptitude game that tests perception.

FIG. 35 is an illustration of a graphical user interface of one embodiment of the system and shows a start page for a cognitive aptitude game that tests math skills.

FIG. 36 is an illustration of a graphical user interface of one embodiment of the system and shows a game page for a cognitive aptitude game that tests math skills.

FIG. 37 is an illustration of a graphical user interface of one embodiment of the system and shows a settings page.

FIG. 38 is an illustration of a graphical user interface of one embodiment of the system and shows an about page.

FIG. 39 is an illustration of a graphical user interface of one embodiment of the system and shows a FAQ page.

FIG. 40 is a block diagram of one embodiment of the present system.

### DESCRIPTION OF THE EMBODIMENTS

To minimize the limitations in the cited references, and to minimize other limitations that will become apparent upon reading and understanding the present specification, the present specification discloses a new and improved method or system for connecting job seekers and potential employers using cognitive aptitude games and tests.

The drawings show illustrative embodiments, but do not depict all embodiments. Other embodiments may be used in addition to or instead of the illustrative embodiments. Details that may be apparent or unnecessary may be omitted for the purpose of saving space or for more effective illustrations. Some embodiments may be practiced with additional components or steps and/or without some or all components or steps provided in the illustrations. When different drawings contain the same numeral, that numeral refers to the same or similar components or steps.

In the following detailed description of various embodiments, numerous specific details are set forth in order to provide a thorough understanding of various aspects of the embodiments. However, these embodiments may be practiced without some or all of these specific details. In other instances, well-known procedures and/or components have not been described in detail so as not to unnecessarily obscure aspects of the embodiments.

While some embodiments are disclosed here, other embodiments will become obvious to those skilled in the art as a result of the following detailed description. These embodiments are capable of modifications of various obvious aspects, all without departing from the spirit and scope of protection. The Figures, and their detailed descriptions, are to be regarded as illustrative in nature and not restrictive. Also, the reference or non-reference to a particular embodiment shall not be interpreted to limit the scope of protection.

In the following detailed description of various embodiments of the invention, numerous specific details are set forth in order to provide a thorough understanding of various aspects of one or more embodiments of the invention. However, one or more embodiments of the invention may be practiced without some or all of these specific details. In other instances, well-known methods, procedures, and/or components have not been described in detail so as not to unnecessarily obscure aspects of embodiments of the invention.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the graphs, figures, and the detailed descriptions thereof, are to be regarded as illustrative in nature and not restrictive. Also, the reference or non-reference to a particular embodiment of the invention shall not be interpreted to limit the scope of the invention.

In the following description, certain terminology is used to describe certain features of one or more embodiments of the invention. For instance, the terms “computer”, “mobile computing device”, and “electronic data processing unit” generally refer to any device that processes information with an integrated circuit chip, including without limitation, mainframe computers, work stations, gaming consoles, servers, desktop computers, portable computers, laptop computers, and embedded computers. Furthermore, the term “mobile computing device” may refer to any wireless devices including cellular phones, tablet computers, personal digital assistants, digital media players, portable game players, and hand-held computers.

As used herein, the term “Internet” generally refers to any collection of networks that utilizes standard protocols, whether Ethernet, Token ring, Wi-Fi, asynchronous transfer mode (ATM), Fiber Distributed Data Interface (FDDI), code division multiple access (CDMA), global systems for mobile communications (GSM), long term evolution (LTE), or any combination thereof.

As used herein, the terms “application”, “software”, or “software application” generally refer to any set of machine-readable instructions on a client machine, web interface, and/or computer system, that directs a computer's processor to perform specific steps, processes, or operations disclosed herein.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 15% of the indicated number or range of numbers. In one embodiment, the term “approximately” and “about”, may refer to a deviance of between 0.0001-40% from the indicated number or range of numbers.

One embodiment of the present disclosure is a system and method of a consumer-facing mobile application designed for job applicants. It features brain games to assess and identify “talent signals” or job-related cognitive abilities, and then matches candidates with appropriate job opportunities based on their game scores and performance in game. Employers also have the ability to reach and recruit candidates through the app, by targeting potential high performers who excel in gameplay on the app.

In one embodiment of the system and method, job seekers download a mobile application (or access the web application) to play gamified cognitive assessments. Job seekers may identify employment fields and positions in which they are interested in for obtaining jobs and/or careers. The system and/or method may match job seekers with potential job opportunities or employers within, preferably a desired specific radius of an identified location.

The system and method of the present disclosure allows job seekers in the marketplace to utilize brain games as a way to identify and showcase their cognitive ability, and to then use those cognitive traits to make themselves visible to employers, to receive job matches based on their profile. In some embodiments, the top scorers of the games may be connected to customized premium job openings in their job field and geographic area.

In some embodiments the system and method may be configured to use brain games to construct a “talent surfacing engine” that connects high potential employees to best-in-class employers.

Some embodiments may be a method of connecting job seekers and employers comprising the steps: developing one or more games that when played test the cognitive abilities of a plurality of players; allowing said plurality of players to access said one or more games; collecting from said one or more players a plurality of information related to themselves and their job preferences; players collecting from a plurality of employers a plurality of job information related to a plurality of open employment positions; collecting and analyzing information related to one or more players; collecting and analyzing a plurality of game scores; matching said one or more players with said plurality open employment positions based on a plurality of game scores; providing the matches to the one or more players. The players may then review the matched open positions and decide whether or not they wish to apply for the various matched jobs.

One embodiment of the present disclosure may be a method of connecting job seekers and employers with job openings comprising the steps: providing a server that comprises a server application; providing one or more user devices each comprise a device application and a display; wherein the server and the one or more user devices are in electronic communication with each other; developing one or more cognitive aptitude games that when played test cognitive abilities of one or more users; wherein the one or more cognitive aptitude games reside on the server and are accessed by the device application, such that the one or more cognitive aptitude games are configured to be played by the one or more users; collecting by the device application a plurality of information about each of the one or more users; wherein the plurality of information comprises information related to the one or more users job preferences and prior work experiences; collecting by the server application a plurality of information about a plurality of employers that have one or more open employment positions; collecting by the server application a plurality of information about the one or more open employment positions; accessing and playing the one or more cognitive aptitude games by the one or more users; collecting a plurality of cognitive aptitude game scores; associating the plurality of cognitive aptitude game scores with the one or more users that played the one or more cognitive aptitude games; matching the one or more users with the plurality open employment positions based on the plurality of cognitive aptitude game scores; and providing the matches to the one or more users. The method may also comprise the steps of accepting one or more job applications for the matches from the one or more users; and sending the one or more job applications to at least one of the plurality of employers. Preferably, at least one of the plurality of employment positions requires a minimum score on at least one of the one or more cognitive aptitude games to be matched. In other embodiments the user might have to get a minimum score on all of the games or game types to be matched. It depends on what the employer requires. The device application may display an overall score progress to the one or more users. The device application may display a list of one or more high scores on the one or more cognitive aptitude games to the one or more users. The device application may display one or more rankings of the one or more users, such that the users may see where they rank by category, by game, or overall. When the one or more users achieve a minimum score, access may be granted to one or more special perks. The required minimum score may be on a category, specific game, overall score, or percentile. One of the one or more special perks is access to meet with a talent scout. The one or more cognitive aptitude games may be selected from the group of games comprising: mental fitness games; verbal games; and math games. At least one of the verbal games may be a vocabulary game and at least one of the mental fitness games may be a memory game. Other perks may include: access to individualized attention from talent scouts or career coaches who provide career and resume tips; access to premium jobs at great employers; the ability to display the user's “credentials” (level achieved in app) to employers when they apply for a specific featured job; and unlocking more games that are not available to other users.

Another embodiment may be a method of connecting job seekers and employers with job openings comprising the steps: providing a server that comprises a server application; providing one or more user devices each comprise a device application and a display; wherein the server and the one or more user devices are in electronic communication with each other; developing one or more cognitive aptitude games that when played test cognitive abilities of one or more users; wherein the one or more cognitive aptitude games reside on the server and are accessed by the device application, such that the one or more cognitive aptitude games are configured to be played by the one or more users; collecting by the device application a plurality of information about each of the one or more users; wherein the plurality of information comprises information related to the one or more users job preferences and prior work experiences; collecting by the server application a plurality of information about a plurality of employers that have one or more open employment positions; collecting by the server application a plurality of information about the one or more open employment positions; wherein at least one of the plurality of employment positions requires a minimum score on at least two of the one or more cognitive aptitude games to be matched; accessing and playing the one or more cognitive aptitude games by the one or more users; collecting a plurality of cognitive aptitude game scores; associating the plurality of cognitive aptitude game scores with the one or more users that played the one or more cognitive aptitude games; matching the one or more users with the plurality open employment positions based on the plurality of cognitive aptitude game scores; providing the matches to the one or more users; accepting one or more job applications for the matches from the one or more users; and sending the one or more job applications to at least one of the plurality of employers. The device application may display an overall score progress to the one or more users. The device application may display a list of one or more high scores on the one or more cognitive aptitude games to the one or more users. The device application may display one or more rankings of the one or more users. When the one or more users achieve a minimum score, access may be granted to one or more special perks, such as meeting with a talent scout. The one or more cognitive aptitude games may be selected from the group of games consisting of: mental fitness games; verbal games; and math games. At least one of the verbal games may be a vocabulary game. At least one of the mental fitness games may be a memory game.

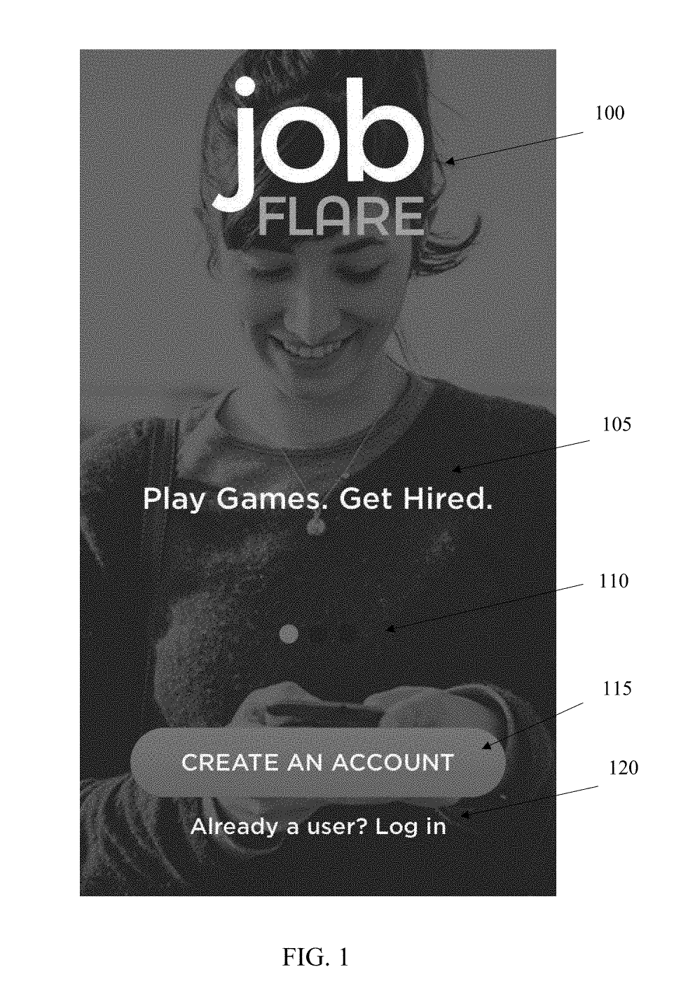

FIG. 1 is an illustration of a graphical user interface of one embodiment of the system and shows the splash page and create an account/login screen. FIG. 1 is a splash or landing page after opening the application software of the present system and method. The application software may be run on an electronic computing device, such as a computer, smartphone, cellphone, tablet, or laptop computer. The Application software is configured to connect, wirelessly and/or wired, to a server. The server may comprise a memory, a processing unit, and a server application. The server may be the Cloud. The server Application may comprise cognitive aptitude games that may be accessed by users. The results of the games are stored on the server and as part of the user's profile and may be used to match the users with job openings.

The user may download the device application, which is presented to the user via the display of the user's device. The displays of the users' devices may present a graphical user interface that allows the user to interact with the application via a keyboard, touch screen, and/or mouse. FIG. 1 shows that the landing page may have a trademark 100, a slogan 105, a create account 115, and a login link 120. The pages 110 show that the landing page may be three side by side pages that may be swiped left and right to open.

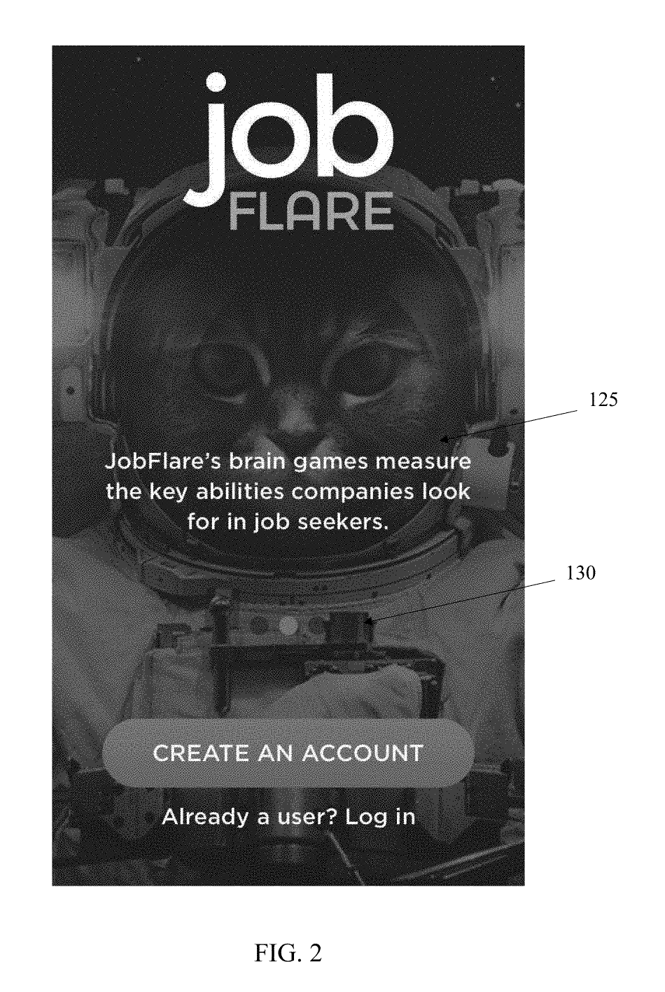

FIG. 2 is an illustration of a graphical user interface of another embodiment of the system and shows the splash page and create an account/login screen. FIG. 2 shows that page 2 130 of the landing page may have further slogan 125.

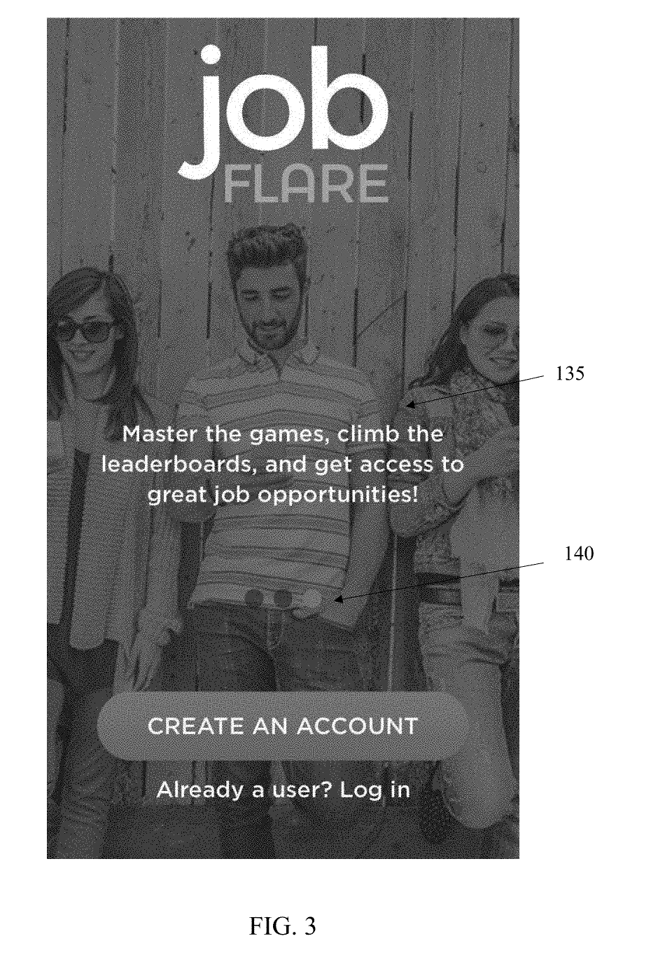

FIG. 3 is an illustration of a graphical user interface of another embodiment of the system and shows the splash page and create an account/login screen. FIG. 3 shows that page 3 140 of the landing page may have further slogan 135.

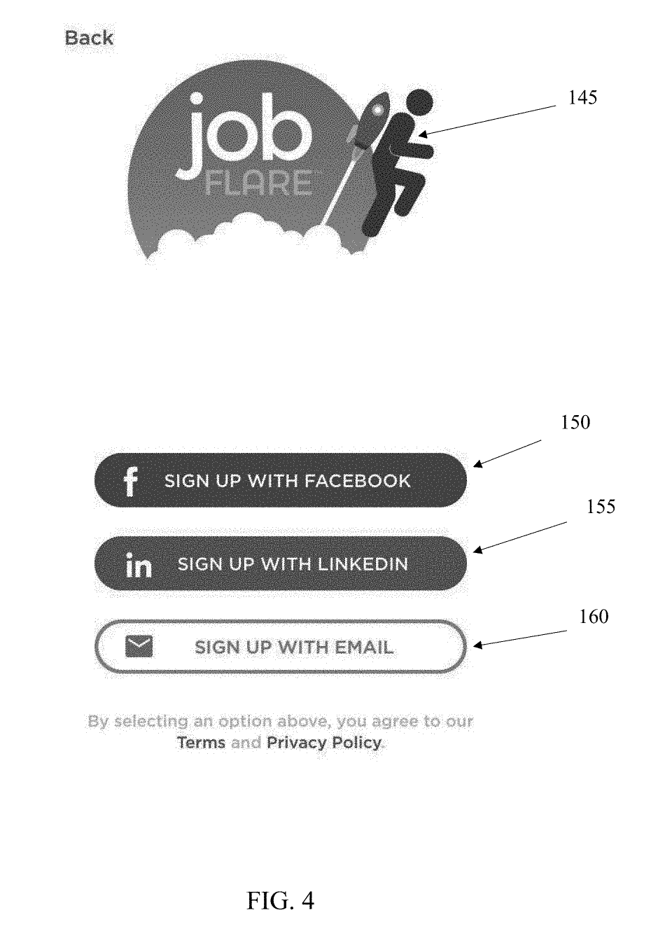

FIG. 4 is an illustration of a graphical user interface of one embodiment of the system and shows the account setup page. Once the user elects to create an account, the create an account is displayed with logo 145 and sign up options 150, 155, 160. The user may elect to sign up with their existing social media credentials or sign up using a web mail.

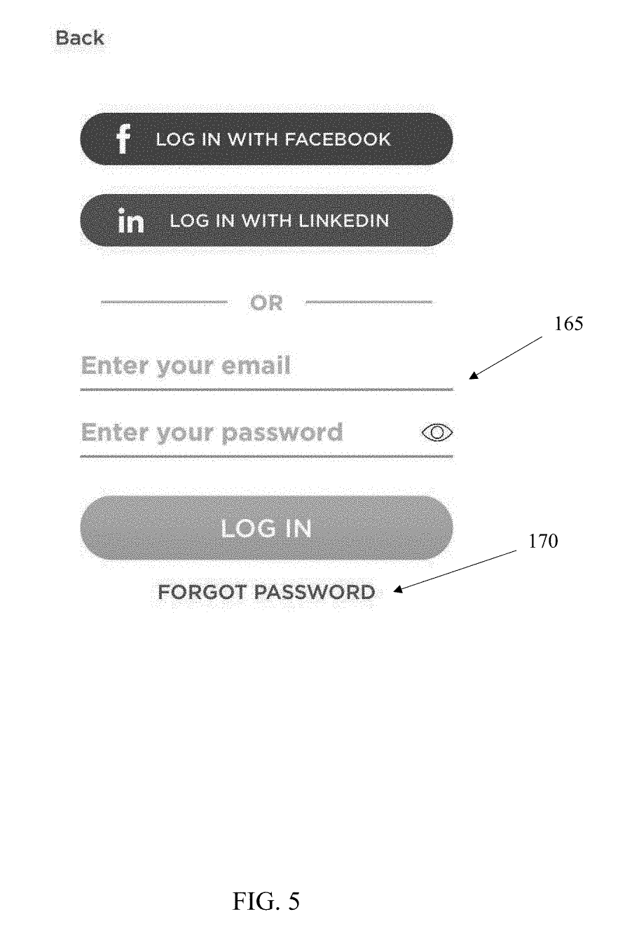

FIG. 5 is an illustration of a graphical user interface of one embodiment of the system and shows the email sign in page. FIG. 5 shows that the user may enter an email address and password 165 to start the create account process or to sign back in using the email credentials. If the user already has an account, the user may retrieve the password by clicking on Forgot Password 170.

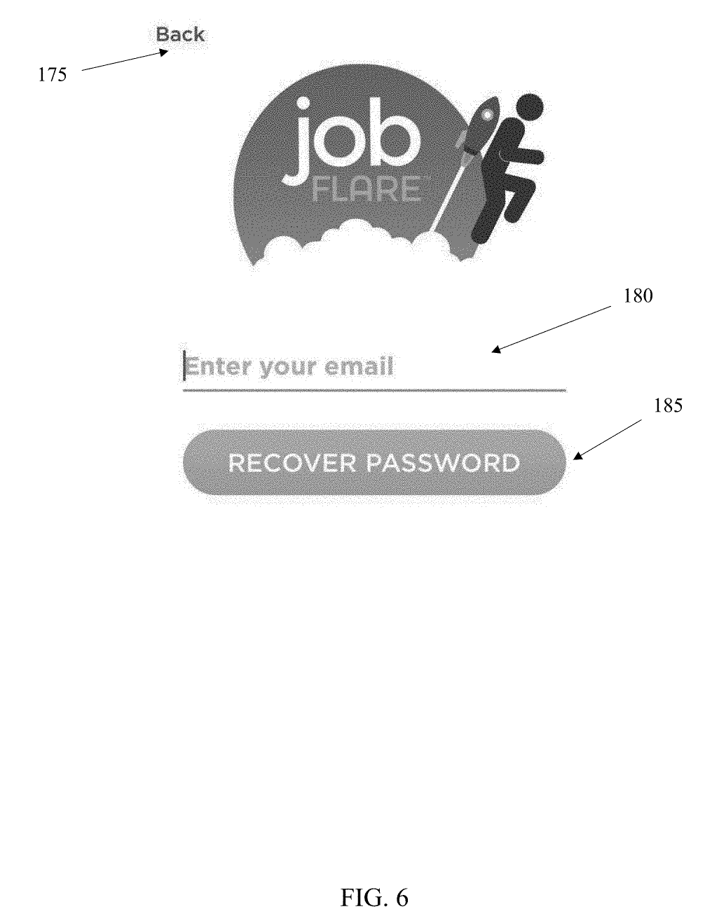

FIG. 6 is an illustration of a graphical user interface of another embodiment of the system and shows the forgot password page. FIG. 6 shows that the application may allow the user to go back 175 to the prior page. FIG. 6 also shows that the user may enter their email/username 180 to recover the password 185.

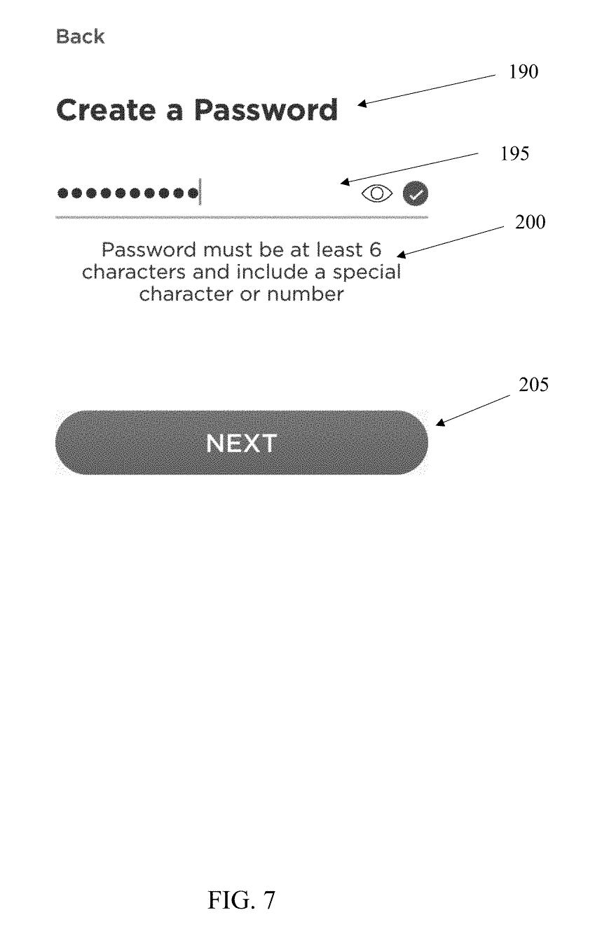

FIG. 7 is an illustration of a graphical user interface of one embodiment of the system and shows the create password page. FIG. 7 shows that the user may create a password 190 by entering a password 195 that is of suitable strength 200. The user may move on by clicking next 205.

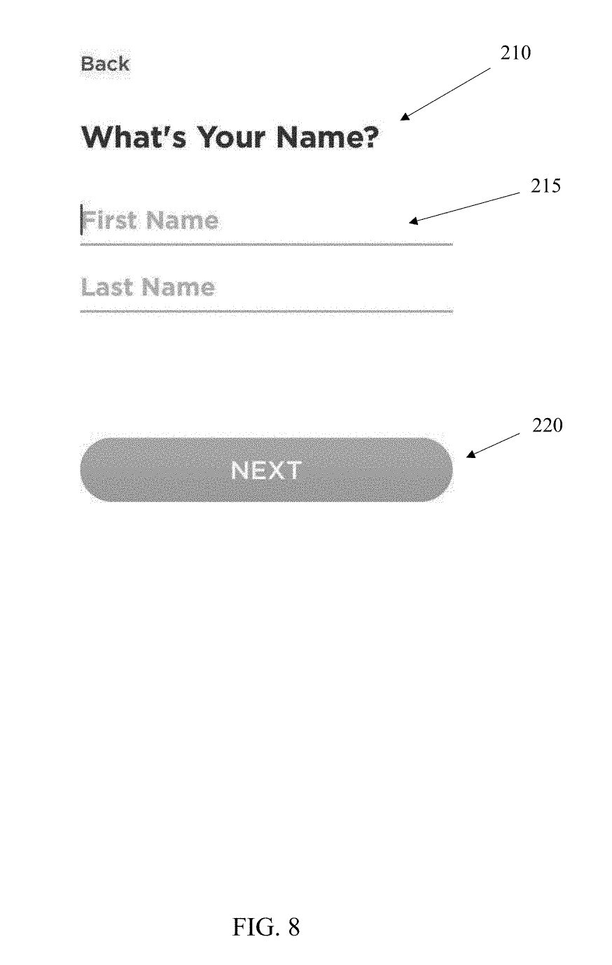

FIG. 8 is an illustration of a graphical user interface of one embodiment of the system and shows one of the pages that gathers information about the user. FIG. 8 shows that the system may request the user's name 210 and allow the user to provide it 215 and move forward by selecting next 220.

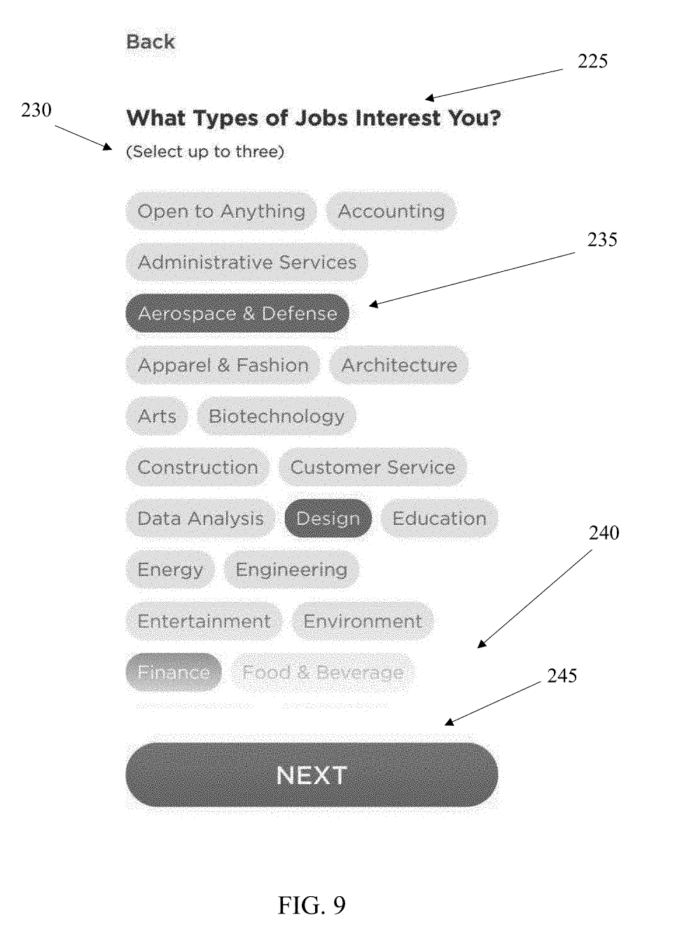

FIG. 9 is an illustration of a graphical user interface of one embodiment of the system and shows that the user may select the types of jobs in which the user is interested. The system may ask the user to select what jobs are of interest 225. The selects may be unlimited or limited 230. The system may provide a list of jobs 240 that the user may scroll through and select. One example of a job that may be selected is aerospace & defense 235. Once the user has selected between 1 and 3 job types, the user selects next 245 to move forward.

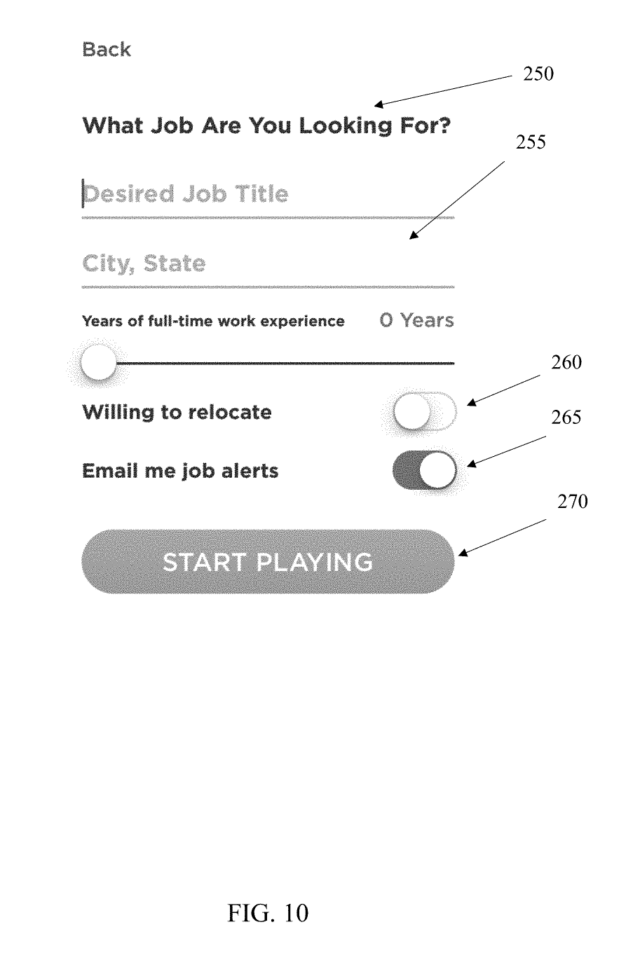

FIG. 10 is an illustration of a graphical user interface of one embodiment of the system and shows that the user may provide additional information about job types being sought, location, experience, and willingness to relocate. The system may ask the user for what type of jobs they want 250. The user may enter the job name, desired location, and input how many years of experience they have 255. The user may input whether they may relocate 260 and ask for emails about job alerts 265. Once the system has gathered user information, the user may then start playing the cognitive aptitude games 270.

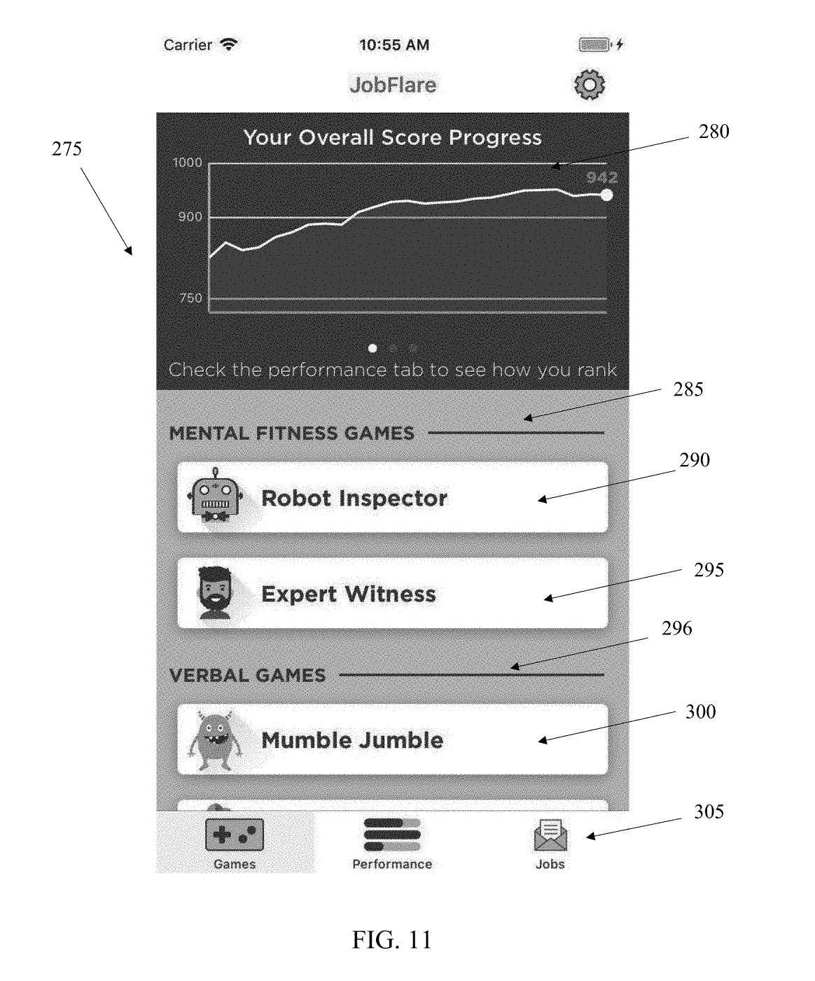

FIG. 11 is an illustration of a graphical user interface of one embodiment of the system and shows the games dashboard first page. FIG. 11 shows that the games dashboard page of the system may have multiple screens, in this case three screens. The first screen 275 may show the overall games score progress 280. The user may select from several different types of cognitive aptitude games. Cognitive skills general refers to a user's ability to learn, process and apply knowledge, analyze/reason, and evaluate/decide. Examples of cognitive skills that may be tested using games include, but are not limited to: Active/Interactive Listening; Adaptive Learning; Analytical Thinking/Analysis; Attention to Detail; Behavioral; Communications; Conflict Resolution; Creative/Critical Thinking; Decision Making; Deductive Reasoning; Logic; Math; Memory; Mental Fitness; Nonverbal and Verbal Communication Skills; Perception; Outward Presentation; Problem Solving; Statistics; Strategy and Strategic Planning; and Writing/Grammar/Vocabulary.

FIG. 11 shows that the user may scroll through different cognitive aptitude games that are sorted by the type of cognitive skill tested, including, but not limited to, mental fitness games 285, verbal games 296, and math games. The games may have specific names, such as Robot Inspector 290, Expert Witness 295; and Mumble Jumble 300. The user may select 305 from the games tab (selected), performance tab, and the jobs tab.

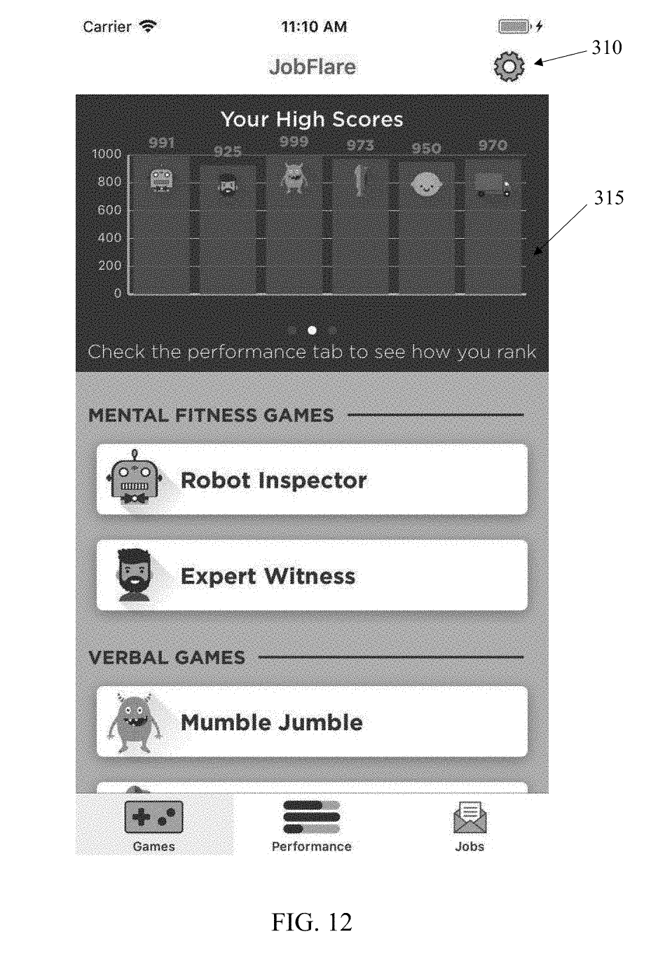

FIG. 12 is an illustration of a graphical user interface of one embodiment of the system and shows the games dashboard second page. The system may allow the user to select settings or tools 310 to set preferences. The second page of the games tab may show the users high scores in each game 315. Preferably each game has an associated graphic or icon that allows the user to easily see what game is associated with what score.

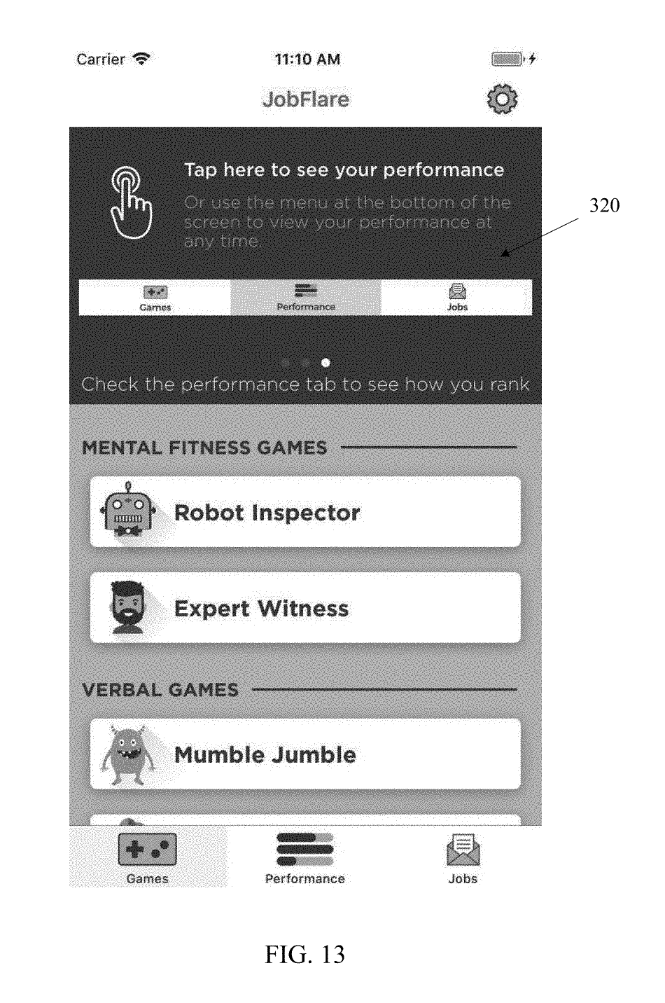

FIG. 13 is an illustration of a graphical user interface of one embodiment of the system and shows the games dashboard third page. FIG. 13 shows that the third page of the games dashboard is an invitation to select the performance tab 320.

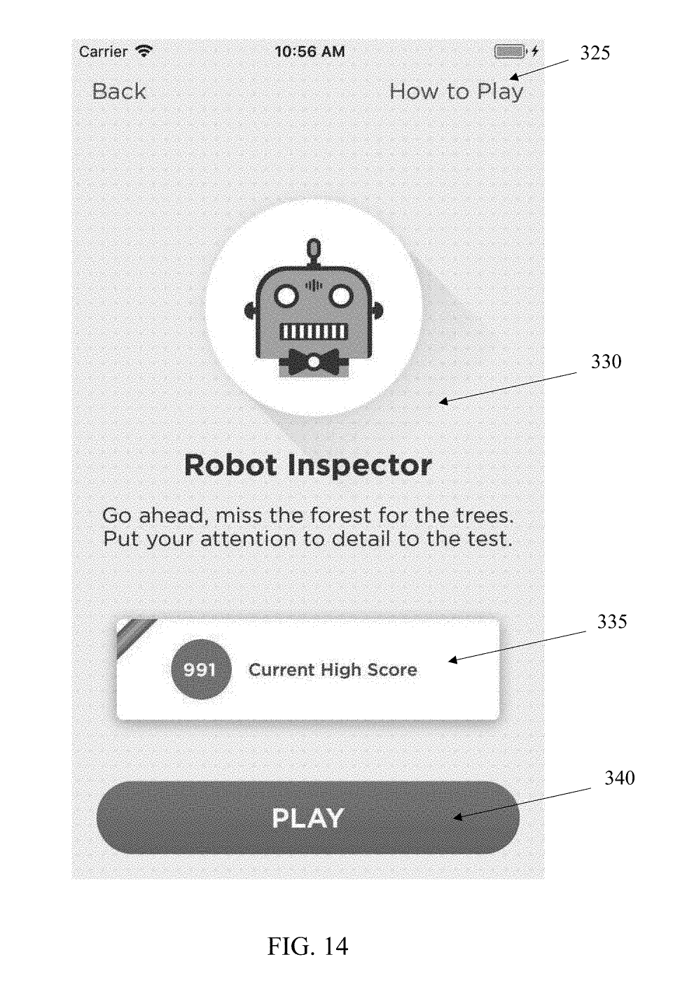

FIG. 14 is an illustration of a graphical user interface of one embodiment of the system and shows the start page for a cognitive aptitude game that tests attention to detail. When the user selects a game, in this case Robot Inspector, the start page 330 is displayed. The user is reminded about the goal of the game, attention to detail, and their high score 335. To start playing the cognitive aptitude game, the user selects play 340. The user may link to a page that explains the game rules and how to play 325.

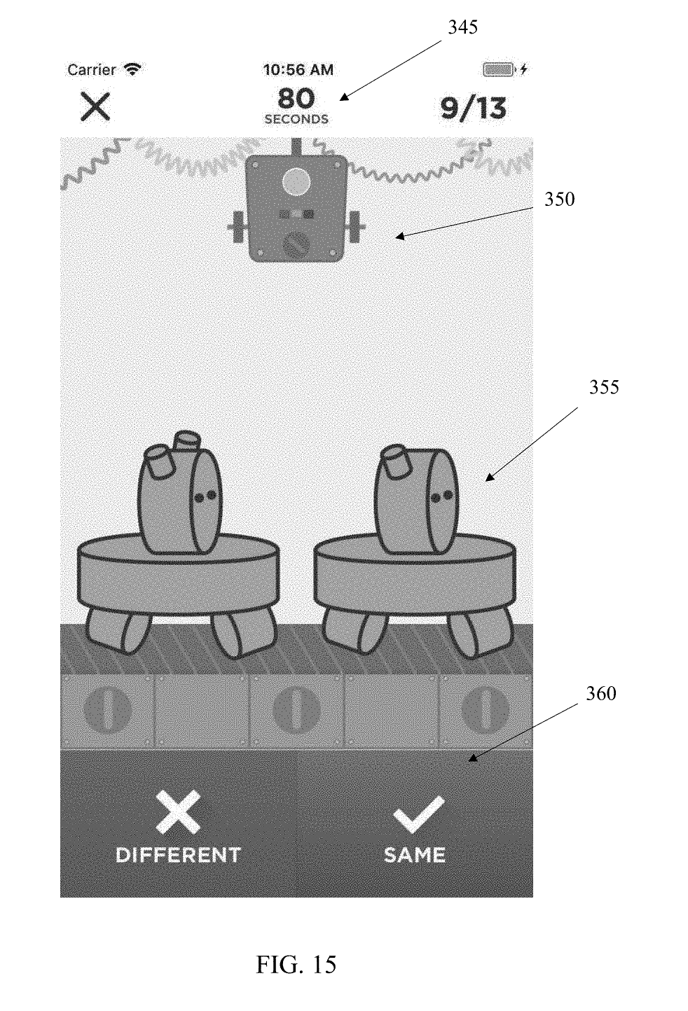

FIG. 15 is an illustration of a graphical user interface of one embodiment of the system and shows a mid-game page for a cognitive aptitude game that tests attention to detail. Once the user starts playing the game, as shown game 9 of 13 in Robot Inspector, the game is timed 345, and provides feedback 350. The user may be presented with a puzzle/problem 355 and choices 360. The user may make a selection and then be presented with another problem until the game is finished. The score may be based on accuracy and how long the user took to complete the game.

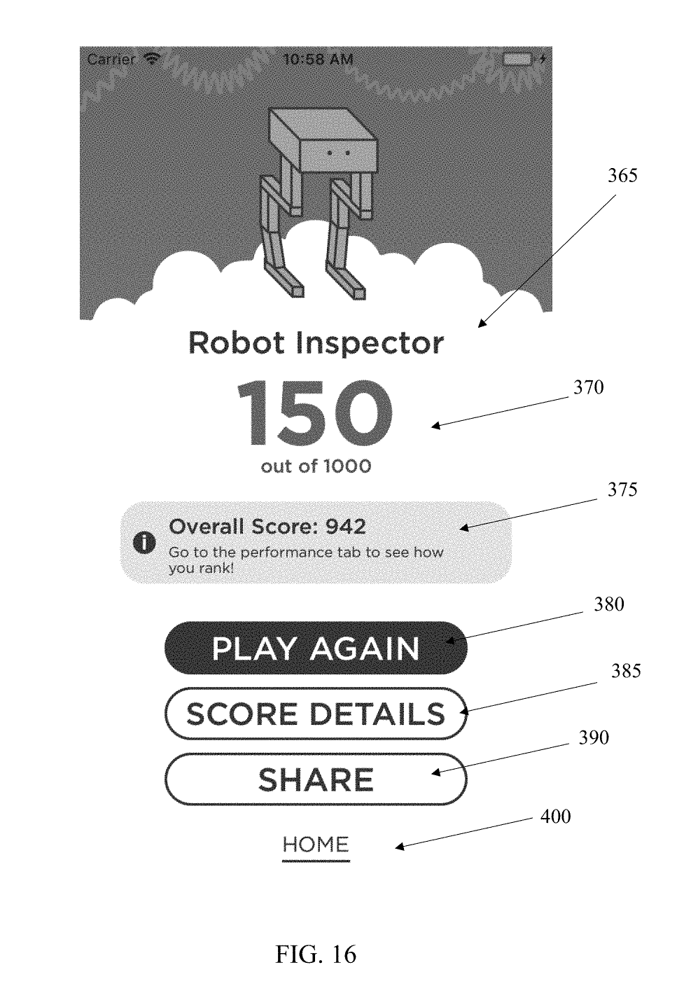

FIG. 16 is an illustration of a graphical user interface of one embodiment of the system and shows an end-game page for a cognitive aptitude game that tests attention to detail. After the user has answered all of the questions, the end page displays what game was played 365, the score out of max score 370, and the user's best score 375. The user may then play again 380, get score details 385, share the score 390, or go to the home/dashboard page 400.

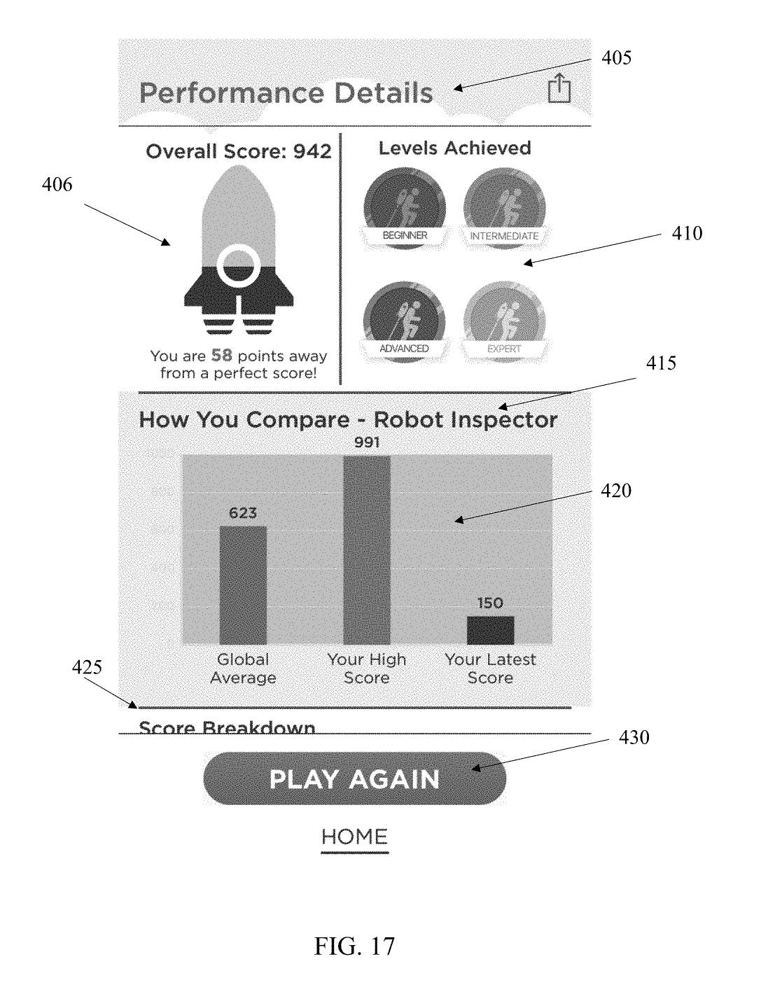

FIG. 17 is an illustration of a graphical user interface of one embodiment of the system and shows the summary performance details for a cognitive aptitude game that tests attention to detail. The score details for Robot Inspector, or any game may comprise a descriptive title 405, high score 406, level of achievement 410, comparison window 415, which compares 420 the current score to the user's high score, and to other scores, such as averages of others and/or highs of others. The user may also select the score breakdown 425 or play again 430.

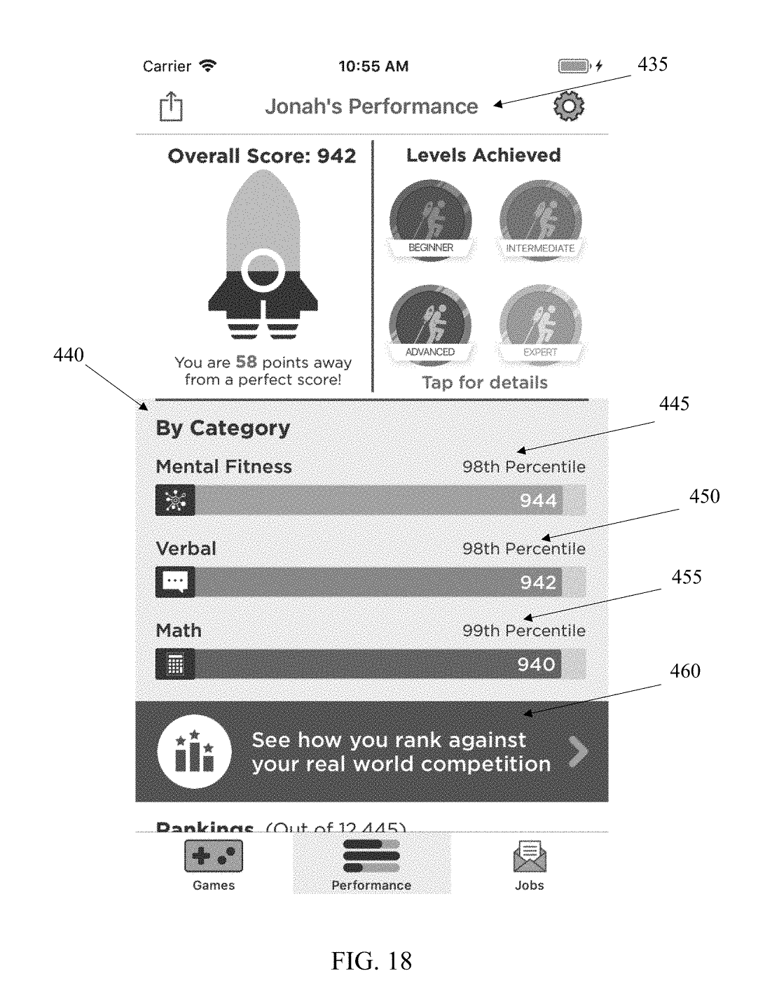

FIG. 18 is an illustration of a graphical user interface of one embodiment of the system and shows a summary performance detail page for a user. FIG. 18 shows the Performance Tab dashboard for a specific user 435. The user's scores may be provided by category 440, with the scores reporting where the person scores 445, 450, 455 relative to the others. Details on the ranks 460 may be accessed.

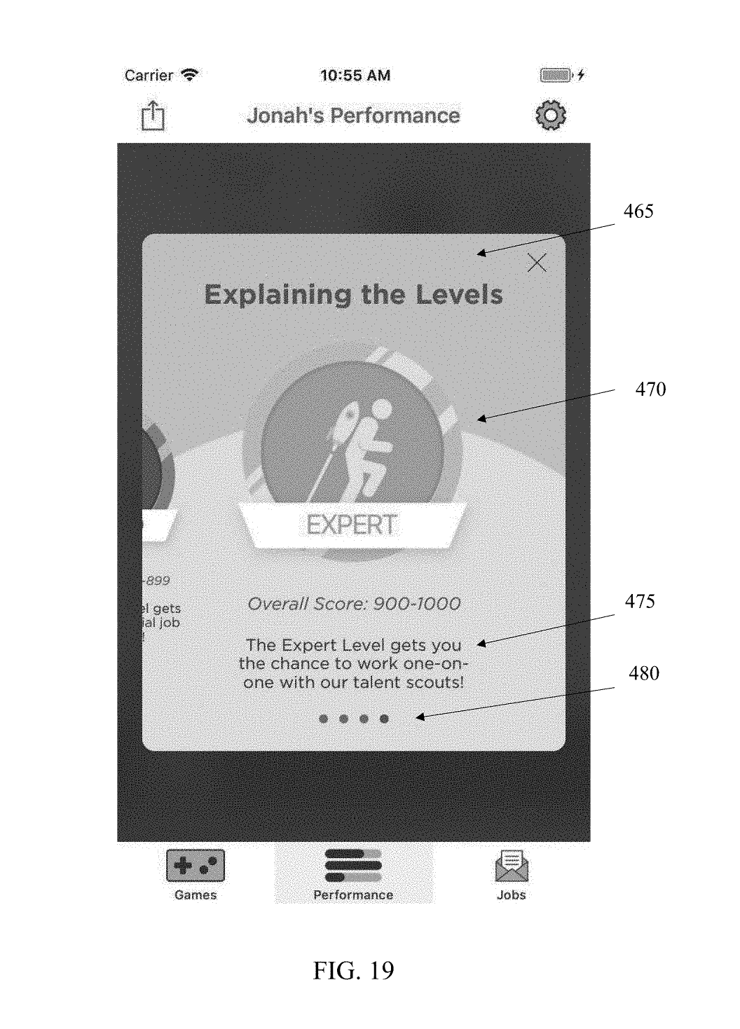

FIG. 19 is an illustration of a graphical user interface of one embodiment of the system and shows a levels detail page. FIG. 19 is page four 480 of the level details page 465 and shows what it takes to be an expert 470. If the user makes the expert level based on their overall score, then they may get access to perks, such as a chance to work one on one with talent scouts 475. Other perks may include: access to individualized attention from talent scouts or career coaches who provide career and resume tips; access to premium jobs at great employers; the ability to display the user's “credentials” (level achieved in app) to employers when they apply for a specific featured job; and unlocking more games that are not available to other users.

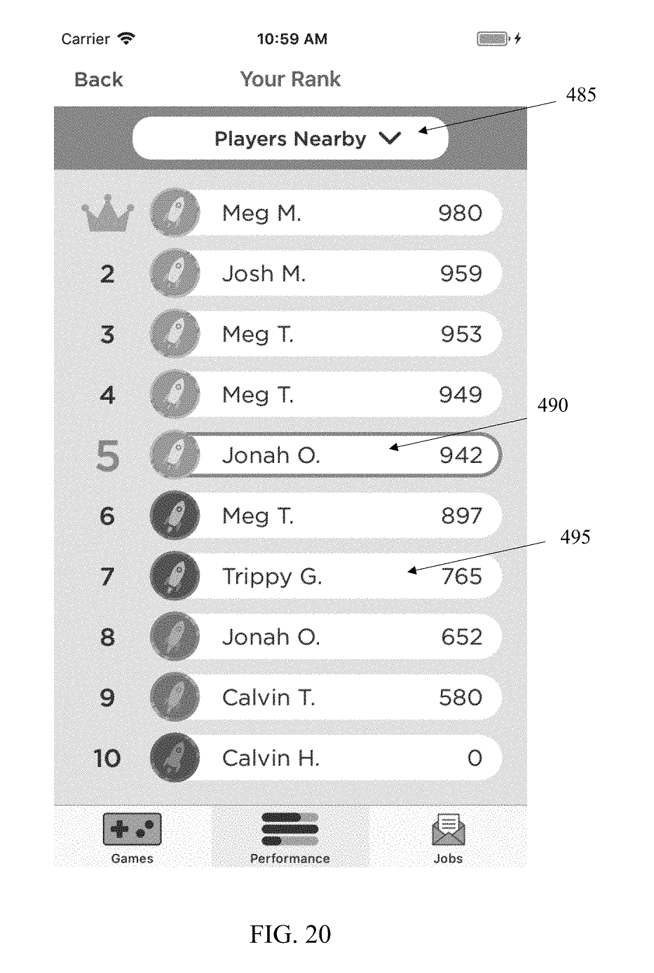

FIG. 20 is an illustration of a graphical user interface of one embodiment of the system and shows a rank of nearby players page. Part of the Performance Tab is showing how the user ranks versus players nearby 485. The user is fifth 490. The user is compared to others 495.

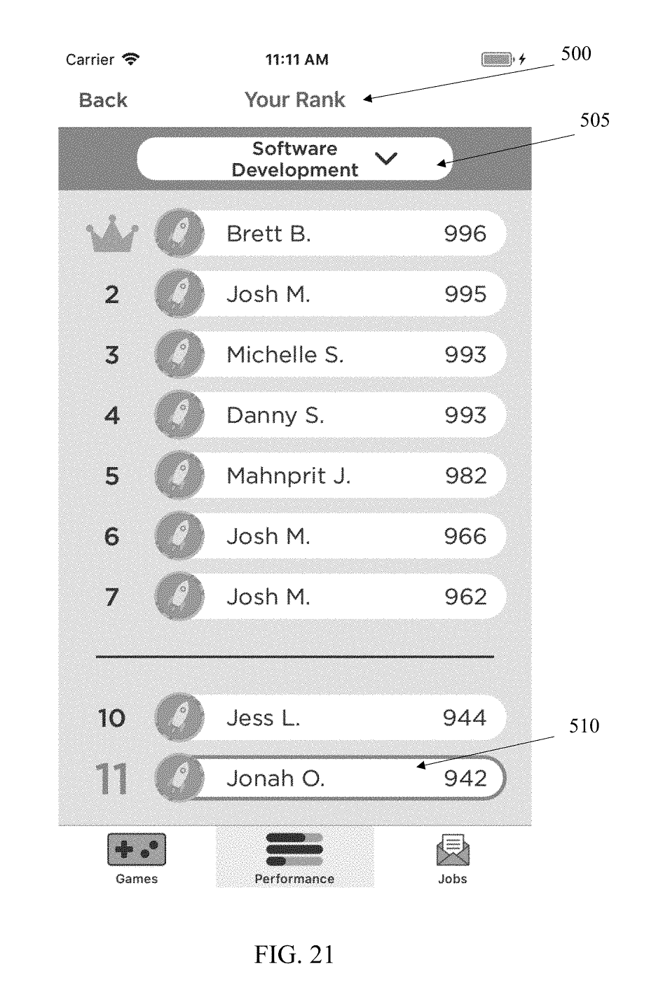

FIG. 21 is an illustration of a graphical user interface of one embodiment of the system and shows a rank of those looking for software development jobs. The performance tab may show the users rank 500 against those looking for software development jobs 505. This user is 11^{th} 510. This type of rankings may make users more competitive and want to raise their score.

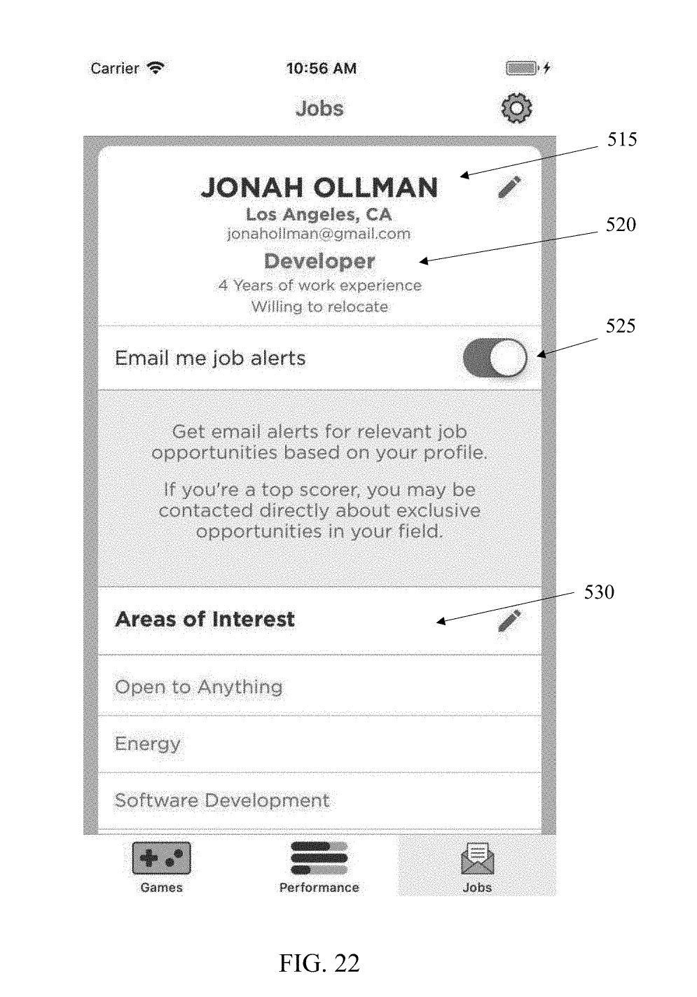

FIG. 22 is an illustration of a graphical user interface of one embodiment of the system and shows a user jobs setup page. FIG. 22 shows the jobs tab for a particular user 515. The user's details 520 may be displayed in the header. The user may toggle alerts 525 on and off. The user may also select or change the types of jobs in which he/she is interested 530.

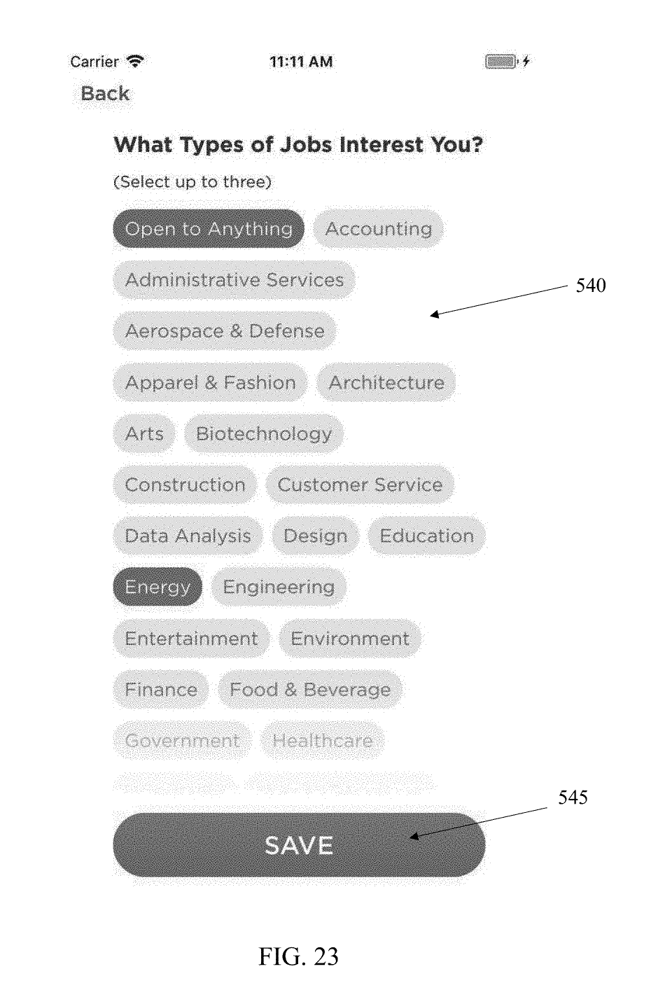

FIG. 23 is an illustration of a graphical user interface of one embodiment of the system and shows a list of jobs of interest to select. The user may later pull up the list of jobs 540 of interest, make changes and save the changes 545.

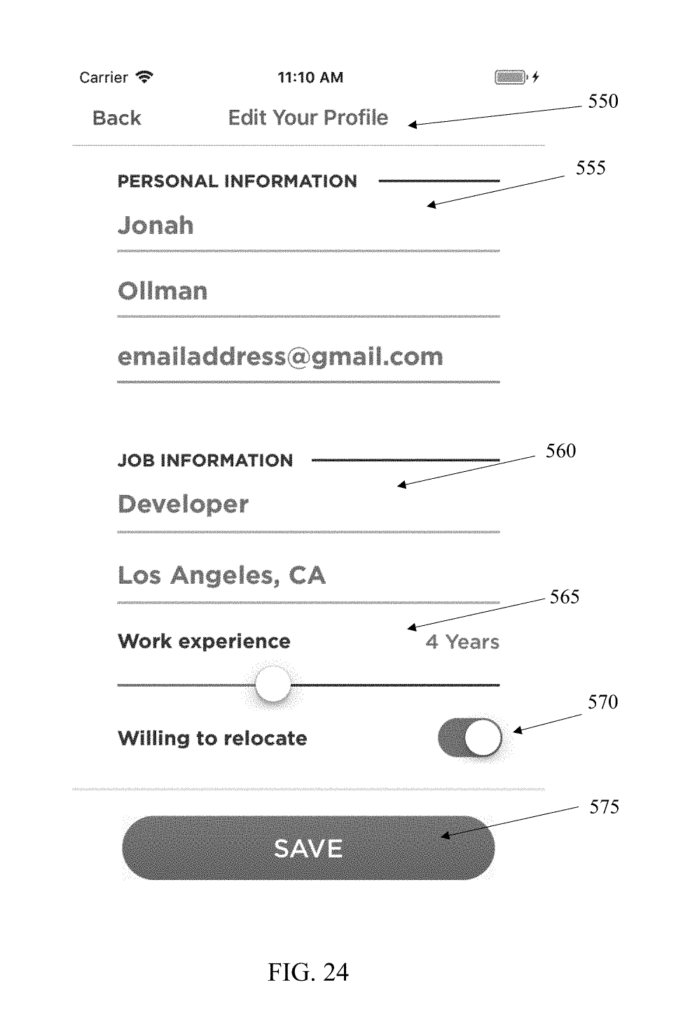

FIG. 24 is an illustration of a graphical user interface of one embodiment of the system and shows an edit profile page. The user may edit their profile 550 by changing the personal information 555, job information 560, work experience 565, willing to relocate 570, and then saving 575.

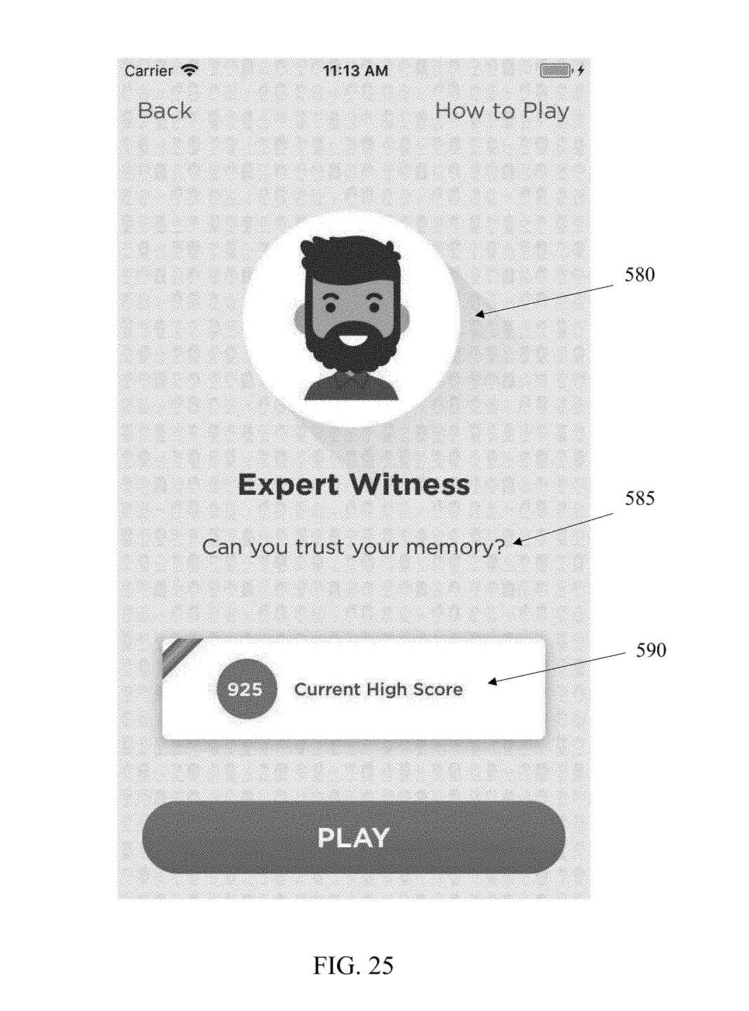

FIG. 25 is an illustration of a graphical user interface of one embodiment of the system and shows the start page for a cognitive aptitude game that tests memory. Another mental fitness game may be a memory game called Expert Witness. The game may have an icon 580 and an explanation 585 so that the user knows what type of game they are playing. The prior high score 590 may also be displayed.

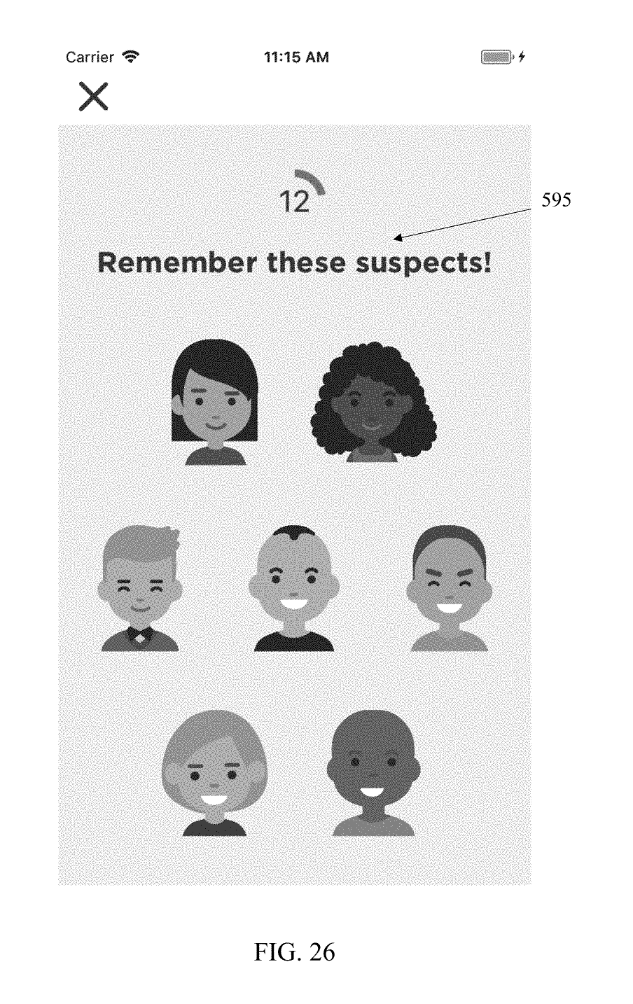

FIG. 26 is an illustration of a graphical user interface of one embodiment of the system and shows a game page for a cognitive aptitude game that tests memory. The game page may display several faces 595, which the user is encouraged to remember. Preferably there is a time limit.

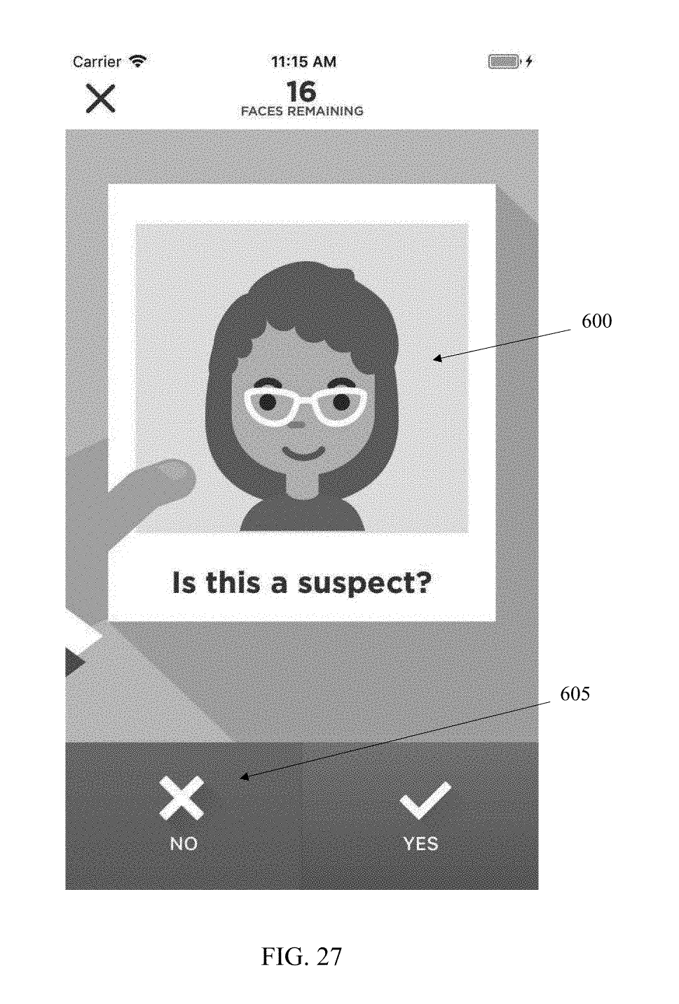

FIG. 27 is an illustration of a graphical user interface of one embodiment of the system and shows another game page for a cognitive aptitude game that tests memory. The user may then be asked to say whether a picture of a person 600 was one of the suspects shown in FIG. 27. The user may select yes or no 605. FIG. 27 shows that 16 faces are remaining in the game.

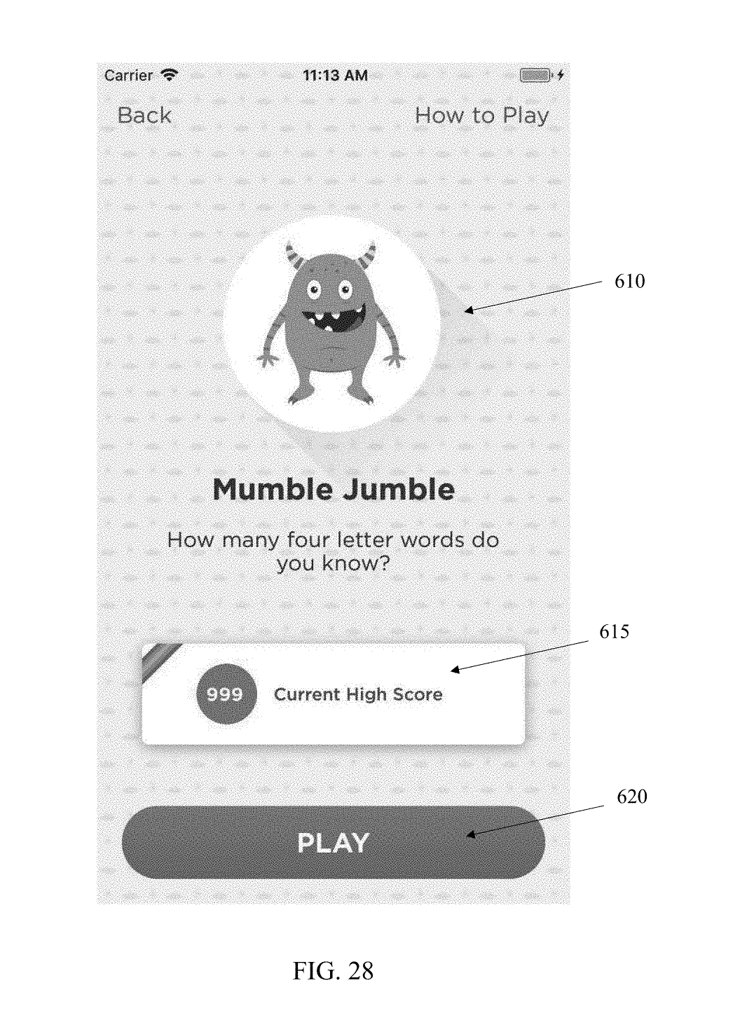

FIG. 28 is an illustration of a graphical user interface of one embodiment of the system and shows the start page for a cognitive aptitude game that tests vocabulary. The verbal or vocabular of the user may be tested by the Mumble Jumble game 610. The high score may be displayed and the user selects play 620 to get started.

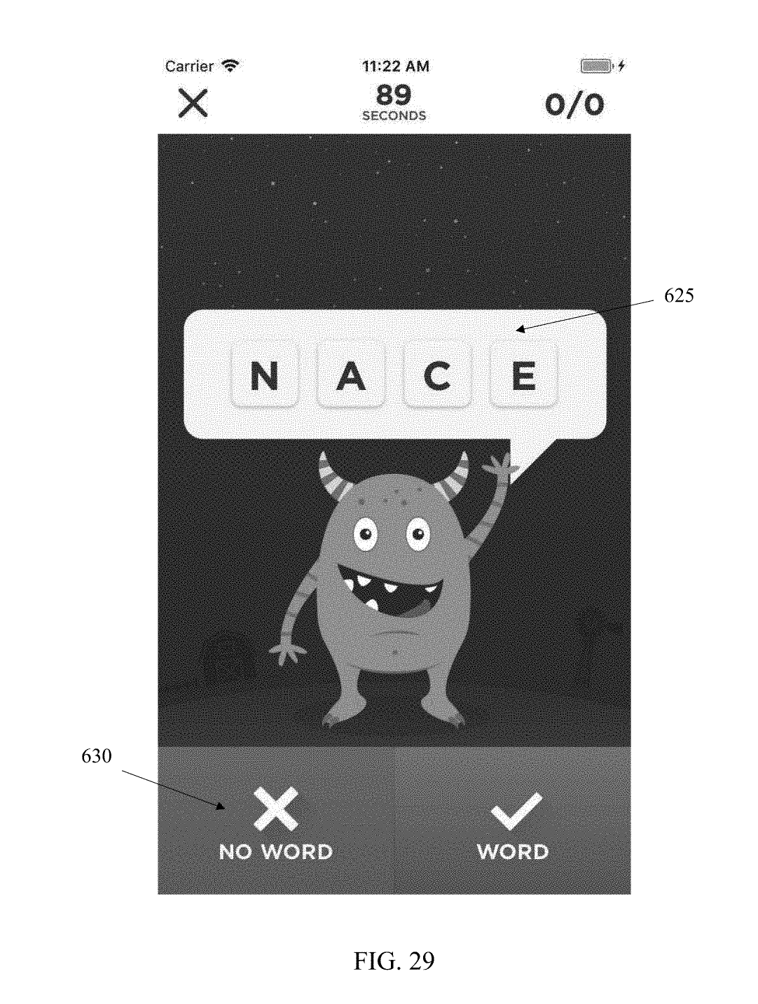

FIG. 29 is an illustration of a graphical user interface of one embodiment of the system and shows a game page for a cognitive aptitude game that tests vocabulary. FIG. 29 shows how the game is timed and requests the user to select 630 whether the letters displayed 625 form a standard vocabulary word.

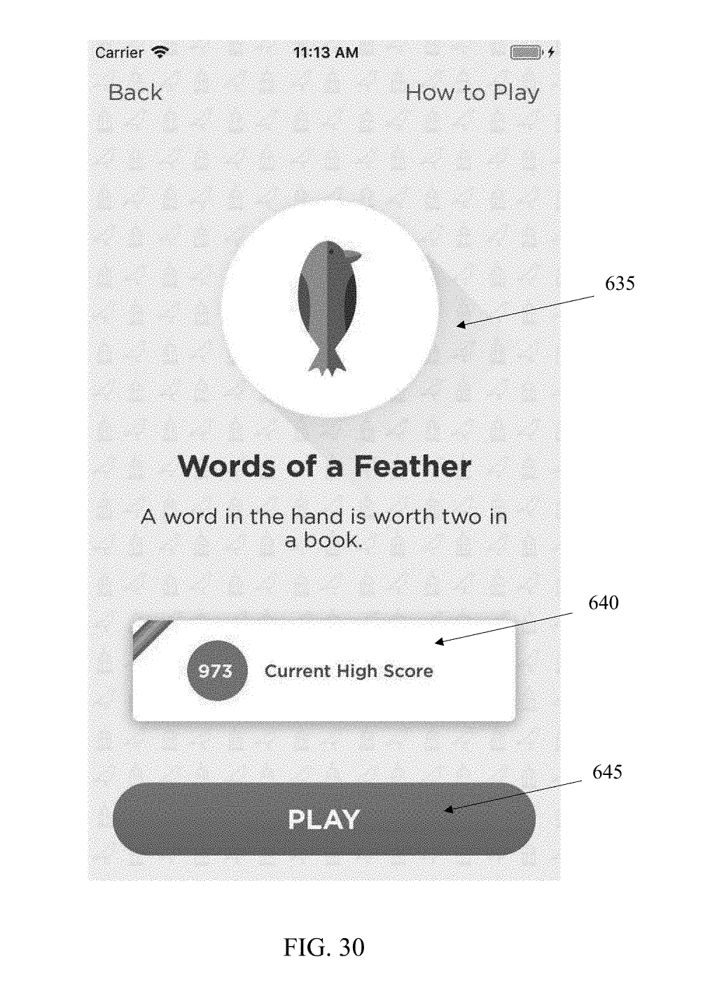

FIG. 30 is an illustration of a graphical user interface of one embodiment of the system and shows another start page for a cognitive aptitude game that tests vocabulary. A second verbal game may be Words of a Feather 635. Each game may have a high score 640 displayed and may have a play button 645 to get started.

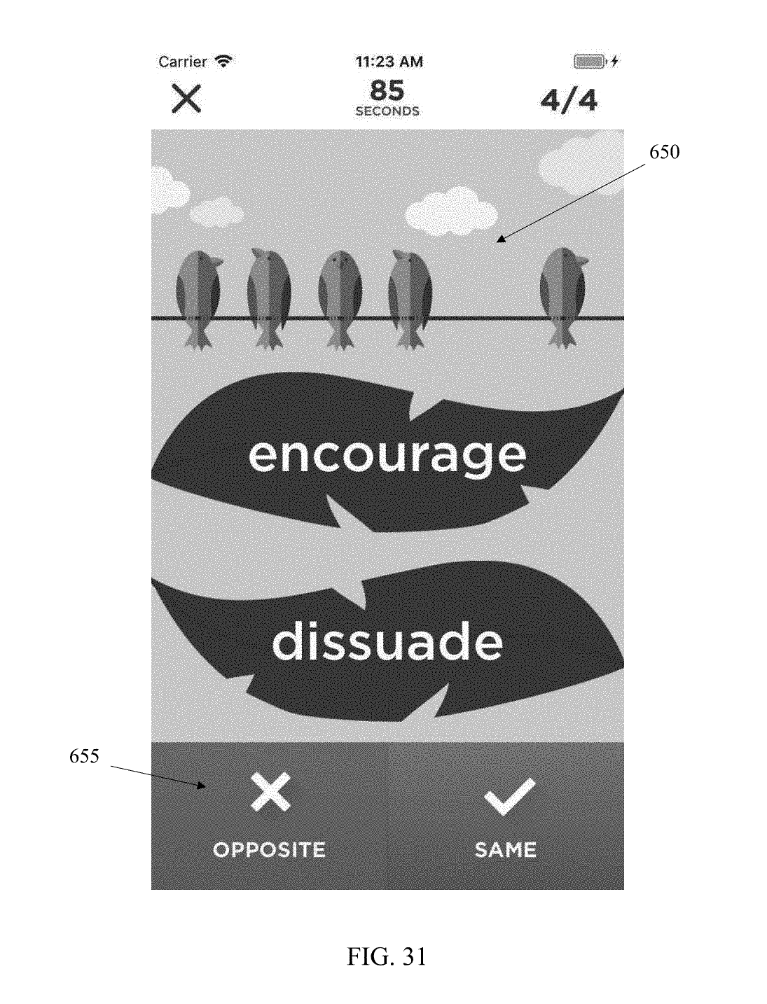

FIG. 31 is an illustration of a graphical user interface of one embodiment of the system and shows another game page for a cognitive aptitude game that tests vocabulary. The game page 650 may display two words and the user should select if they are synonyms or antonyms 655. Other vocabulary questions may be asked and the game may be timed, as shown.

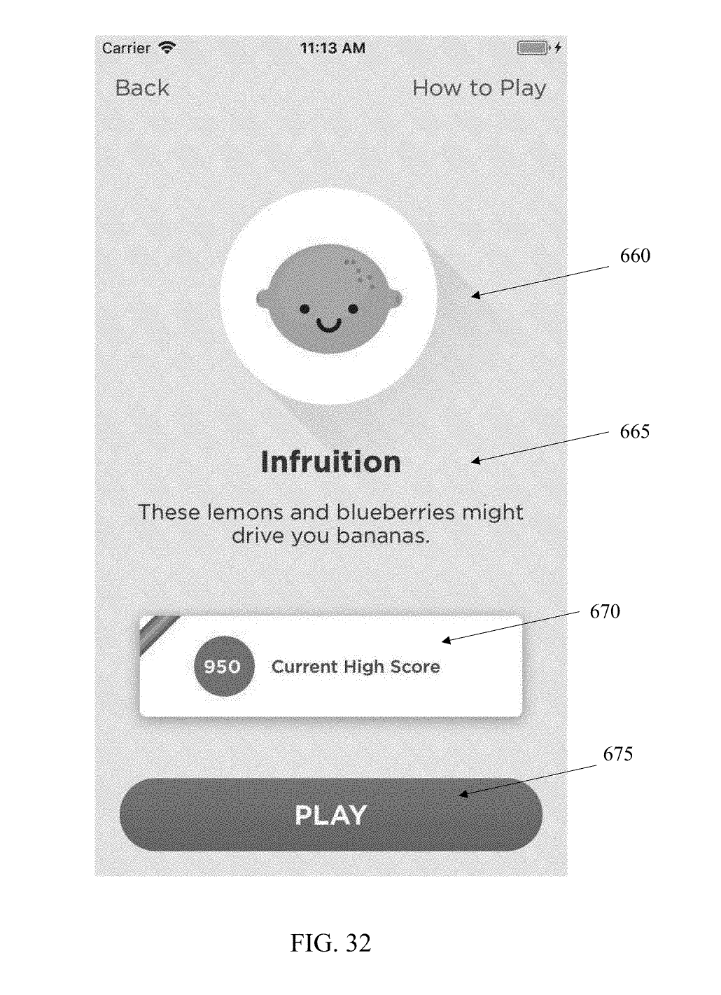

FIG. 32 is an illustration of a graphical user interface of one embodiment of the system and shows a start page for a cognitive aptitude game that tests perception. The perception game 660 may be titled Infruition 665, as a play on intuition. Each game may have a high score 670 displayed and may have a play button 675 to get started.

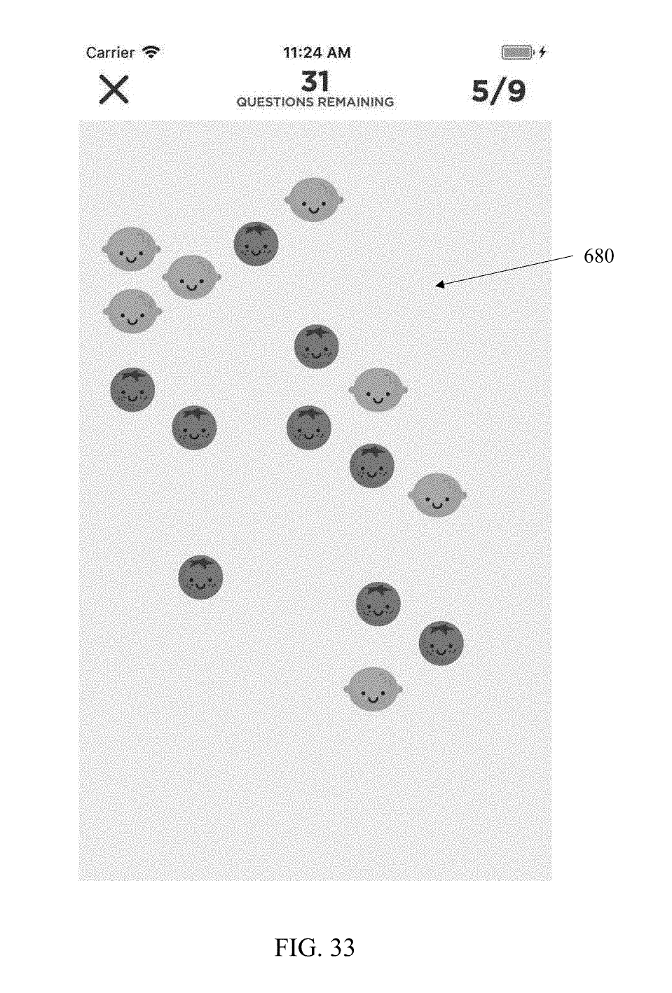

FIG. 33 is an illustration of a graphical user interface of one embodiment of the system and shows a game page for a cognitive aptitude game that tests perception. The game may state how many questions remain and may display for a limited time a picture showing two different articles 680.

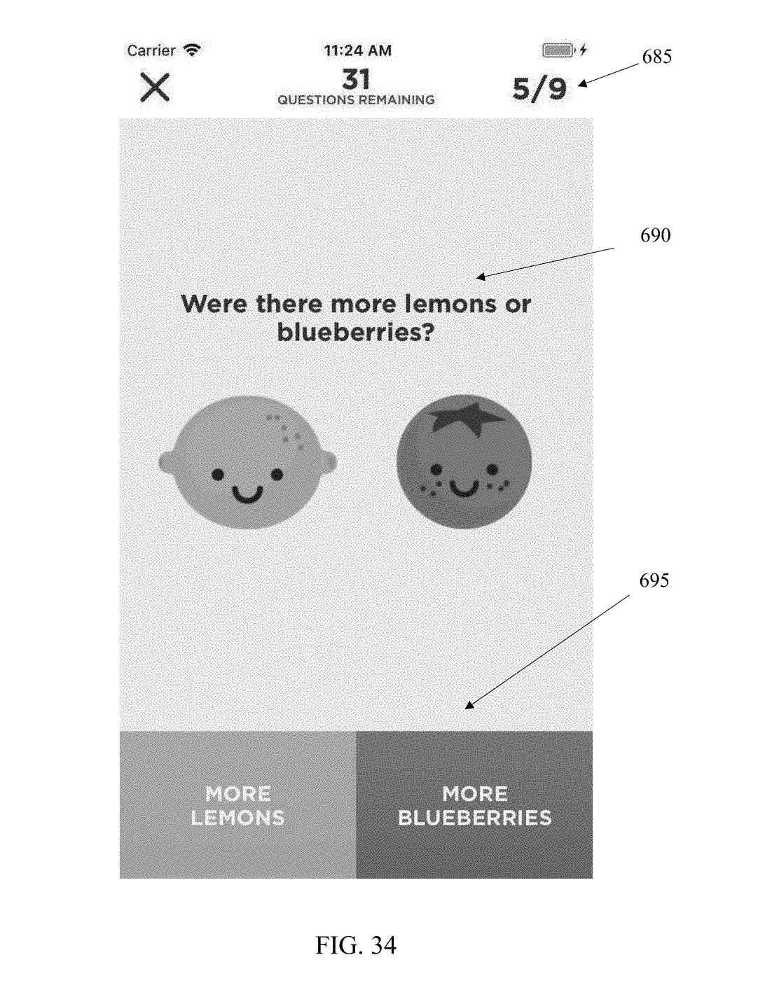

FIG. 34 is an illustration of a graphical user interface of one embodiment of the system and shows another game page for a cognitive aptitude game that tests perception. The user should select 695 whether more lemons or blueberries 690 where shown in the game page shown in FIG. 33.

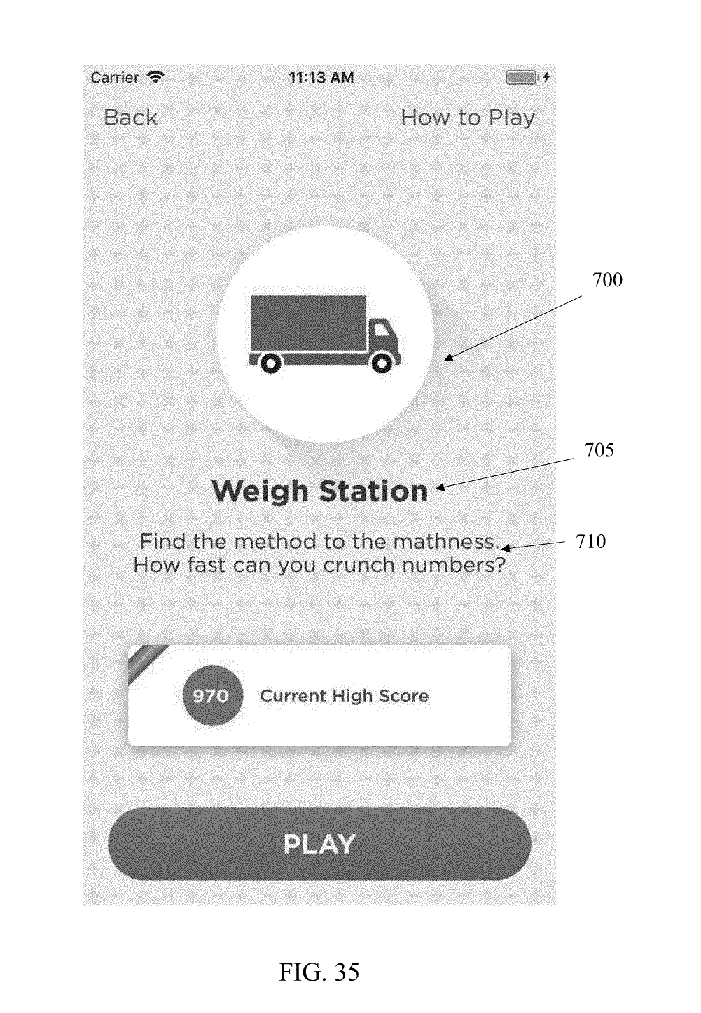

FIG. 35 is an illustration of a graphical user interface of one embodiment of the system and shows a start page for a cognitive aptitude game that tests math skills. Another type of cognitive skill assessed is math and number processing skills. The icon 700 may be associated with a game title 705 and a brief explanation 710 of the game, which as shown may be Weigh Station.

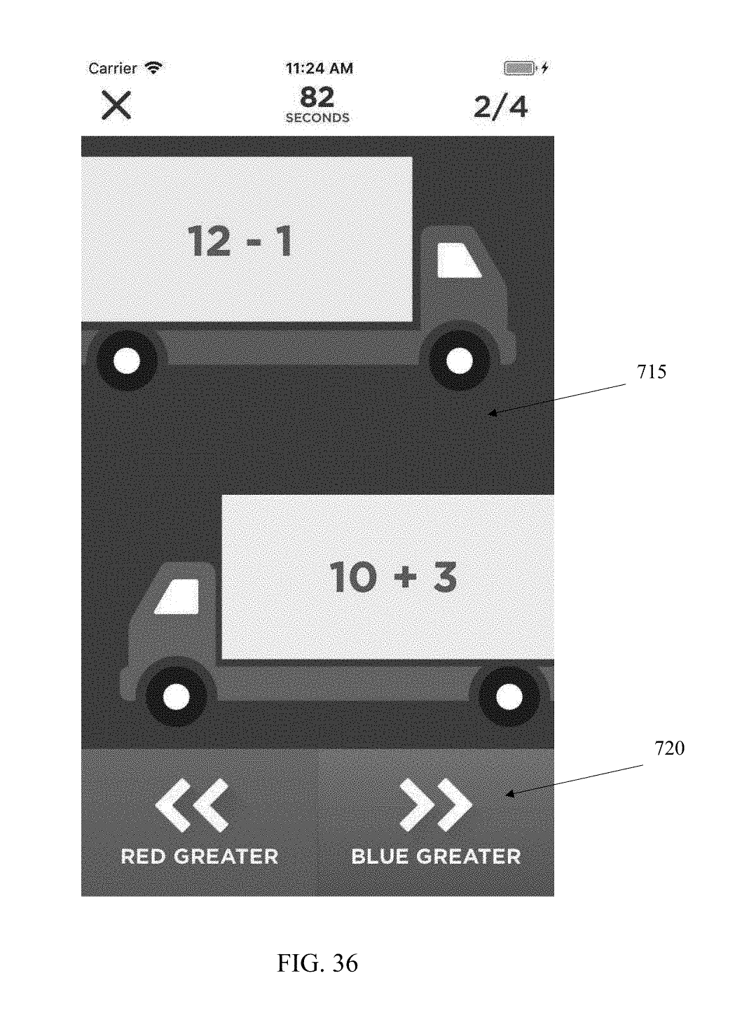

FIG. 36 is an illustration of a graphical user interface of one embodiment of the system and shows a game page for a cognitive aptitude game that tests math skills. FIG. 36 shows that the math game may be timed and the user should select 720 which truck has the higher equation result 715. FIG. 36 shows that the game may be timed.

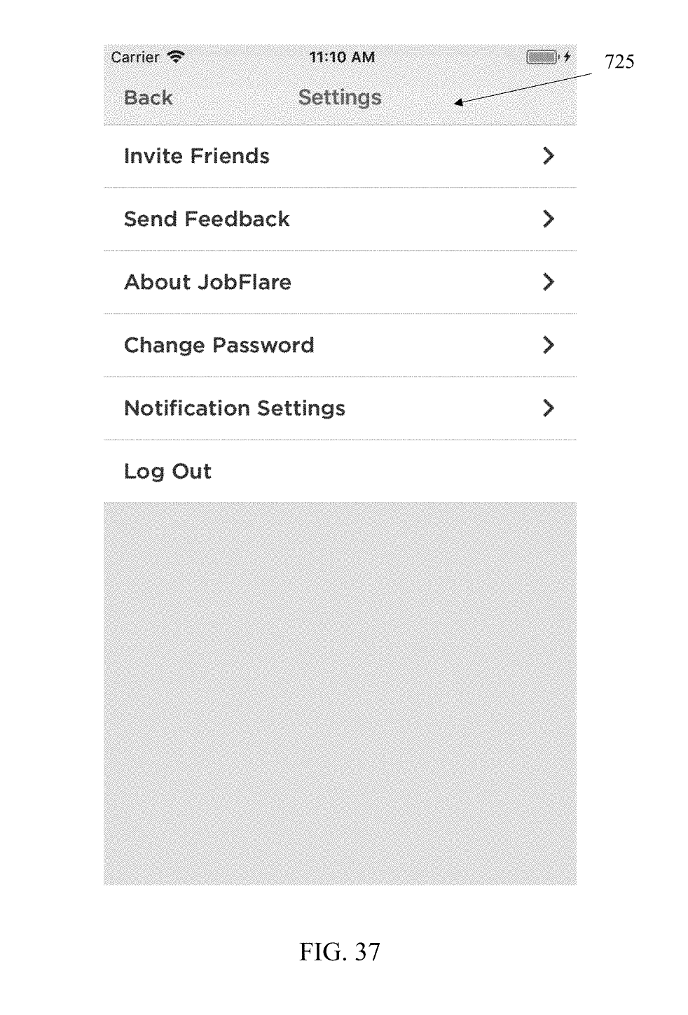

FIG. 37 is an illustration of a graphical user interface of one embodiment of the system and shows a settings page. The settings page 725 may allow the user to invite friends, give feedback, get information about the application, change their password, set notifications, and/or logout of the application.

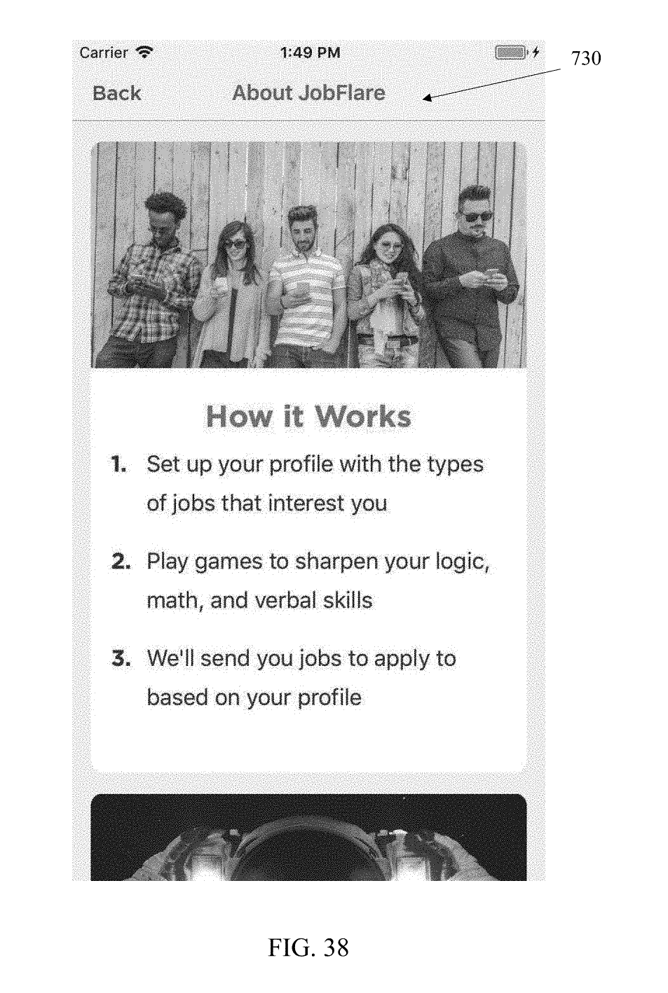

FIG. 38 is an illustration of a graphical user interface of one embodiment of the system and shows an about page. The about application page 730 may detail how the application is designed to help the user. FIG. 38 shows that the application allows the user to set their profiles, play cognitive games, and then, based on the game scores, expose the users to jobs. These jobs might require a minimum level of score to even be considered.

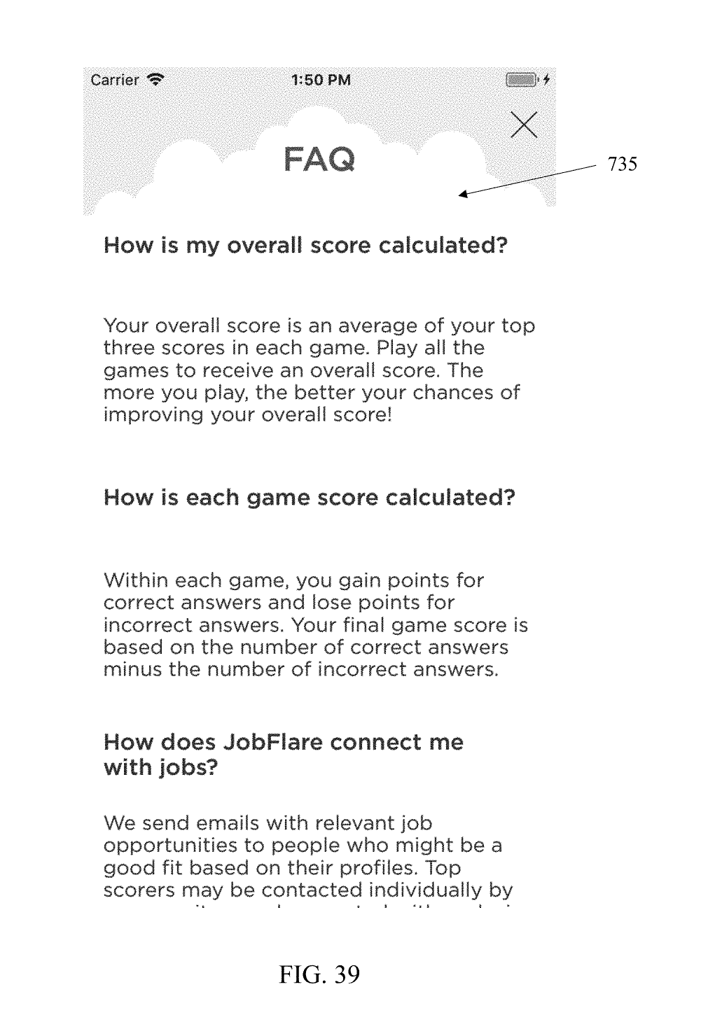

FIG. 39 is an illustration of a graphical user interface of one embodiment of the system and shows a FAQ page. The Frequently Asked Questions Page 735 may provide answers to usual questions about the Application.

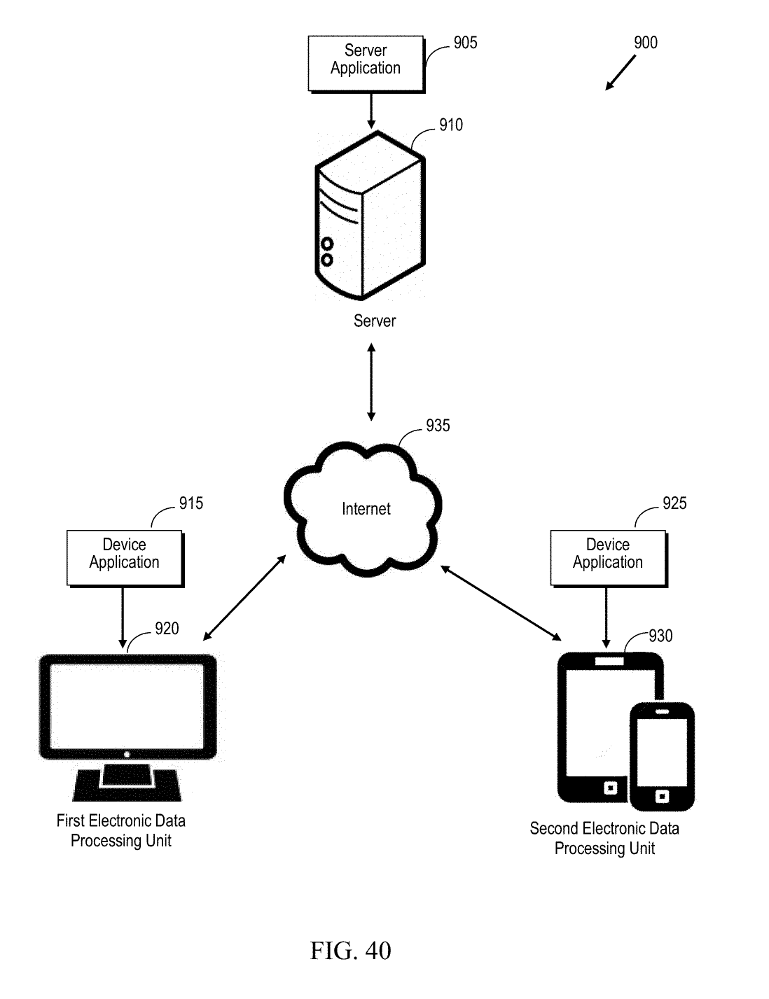

FIG. 40 is a block diagram of one embodiment of the present system. FIG. 40 shows that the system 900 may comprise a server 910, one or more devices 920 and 930, shown as first and second electronic data processing units, server application 905 and device Application 915, 925. The device applications 915, 925 may be connected to the server application 905 through the internet 935. The device applications 915, 925 may display to the users on the user devices the graphical user interfaces shown in FIGS. 1-39. This allows the user to play the cognitive games and be exposed to open job positions based on the user's game scores. The user devices must have displays and interface options (keyboards, microphone, speakers, touch screens, and/or mice) to allow the user to input answers to the games.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A method of connecting job seekers and employers with job openings comprising the steps:
providing a server that comprises a server application;
providing one or more user devices each comprise a device application and a display;
wherein said server and said one or more user devices are in electronic communication with each other;
developing one or more cognitive aptitude games that when played test cognitive abilities of one or more users;
wherein said one or more cognitive aptitude games reside on said server and are accessed by said device application, such that said one or more cognitive aptitude games are configured to be played by said one or more users;
collecting by said device application a plurality of information about each of said one or more users;
wherein said plurality of information comprises information related to said one or more users job preferences and prior work experiences;
collecting by said server application a plurality of information about a plurality of employers that have one or more open employment positions;
collecting by said server application a plurality of information about said one or more open employment positions;
accessing and playing said one or more cognitive aptitude games by said one or more users;
collecting a plurality of cognitive aptitude game scores;
associating said plurality of cognitive aptitude game scores with said one or more users that played said one or more cognitive aptitude games;
matching said one or more users with said plurality open employment positions based on said plurality of cognitive aptitude game scores; and
providing the matches to said one or more users.

2. The method of claim 1, further comprising:
accepting one or more job applications for the matches from said one or more users;
sending said one or more job applications to at least one of said plurality of employers.

3. The method of claim 2, wherein at least one of said plurality of employment positions requires a minimum score on at least one of said one or more cognitive aptitude games to be matched.

4. The method of claim 3, wherein said device application displays an overall score progress to said one or more users.

5. The method of claim 4, wherein said device application displays a list of one or more high scores on said one or more cognitive aptitude games to said one or more users.

6. The method of claim 5, wherein said device application displays one or more rankings of said one or more users.

7. The method of claim 6, wherein when said one or more users achieve a minimum score access is granted to one or more special perks.

8. The method of claim 7, wherein one of said one or more special perks is access to meet with a talent scout.

9. The method of claim 5, wherein said one or more cognitive aptitude games are selected from the group of games consisting of: mental fitness games; verbal games; and math games.

10. The method of claim 9, wherein at least one of said verbal games is a vocabulary game.

11. The method of claim 9, wherein at least one of said mental fitness games is a memory game.

12. A method of connecting job seekers and employers with job openings comprising the steps:
providing a server that comprises a server application;
providing one or more user devices each comprise a device application and a display;
wherein said server and said one or more user devices are in electronic communication with each other;
developing one or more cognitive aptitude games that when played test cognitive abilities of one or more users;
wherein said one or more cognitive aptitude games reside on said server and are accessed by said device application, such that said one or more cognitive aptitude games are configured to be played by said one or more users;
collecting by said device application a plurality of information about each of said one or more users;
wherein said plurality of information comprises information related to said one or more users job preferences and prior work experiences;
collecting by said server application a plurality of information about a plurality of employers that have one or more open employment positions;
collecting by said server application a plurality of information about said one or more open employment positions;
wherein at least one of said plurality of employment positions requires a minimum score on at least two of said one or more cognitive aptitude games to be matched;
accessing and playing said one or more cognitive aptitude games by said one or more users;
collecting a plurality of cognitive aptitude game scores;
associating said plurality of cognitive aptitude game scores with said one or more users that played said one or more cognitive aptitude games;
matching said one or more users with said plurality open employment positions based on said plurality of cognitive aptitude game scores;
providing the matches to said one or more users;
accepting one or more job applications for the matches from said one or more users; and
sending said one or more job applications to at least one of said plurality of employers.

13. The method of claim 12, wherein said device application displays an overall score progress to said one or more users.

14. The method of claim 12, wherein said device application displays a list of one or more high scores on said one or more cognitive aptitude games to said one or more users.

15. The method of claim 12, wherein said device application displays one or more rankings of said one or more users.

16. The method of claim 12, wherein when said one or more users achieve a minimum score access is granted to one or more special perks.

17. The method of claim 16, wherein one of said one or more special perks is access to meet with a talent scout.

18. The method of claim 12, wherein said one or more cognitive aptitude games are selected from the group of games consisting of: mental fitness games; verbal games; and math games.

19. The method of claim 18, wherein at least one of said verbal games is a vocabulary game and wherein at least one of said mental fitness games is a memory game.

20. A method of connecting job seekers and employers with job openings comprising the steps:
providing a server that comprises a server application;
providing one or more user devices each comprise a device application and a display;
wherein said server and said one or more user devices are in electronic communication with each other;
developing one or more cognitive aptitude games that when played test cognitive abilities of one or more users;
wherein said one or more cognitive aptitude games reside on said server and are accessed by said device application, such that said one or more cognitive aptitude games are configured to be played by said one or more users;
collecting by said device application a plurality of information about each of said one or more users;
wherein said plurality of information comprises information related to said one or more users job preferences and prior work experiences;
collecting by said server application a plurality of information about a plurality of employers that have one or more open employment positions;
collecting by said server application a plurality of information about said one or more open employment positions;
wherein at least one of said plurality of employment positions requires a minimum score on at least one of said one or more cognitive aptitude games to be matched.
accessing and playing said one or more cognitive aptitude games by said one or more users;
collecting a plurality of cognitive aptitude game scores;
associating said plurality of cognitive aptitude game scores with said one or more users that played said one or more cognitive aptitude games;
matching said one or more users with said plurality open employment positions based on said plurality of cognitive aptitude game scores;
providing the matches to said one or more users;
accepting one or more job applications for the matches from said one or more users;
sending said one or more job applications to at least one of said plurality of employers;
wherein said device application displays an overall score progress to said one or more users;
wherein said device application displays a list of one or more high scores on said one or more cognitive aptitude games to said one or more users;
wherein said device application displays one or more rankings of said one or more users;
wherein when said one or more users achieve a minimum score access is granted access to meet with a talent scout;
wherein said one or more cognitive aptitude games are selected from the group of games consisting of: mental fitness games; verbal games; and math games;
wherein at least one of said verbal games is a vocabulary game; and
wherein at least one of said mental fitness games is a memory game.
